(19) United States
(12) Patent Application Publication
(10) Pub. No.: US 2025/0102345 A1
(43) Pub. Date: Mar. 27, 2025

(54) LEVEL METER

(71) Applicant: Keyence Corporation, Osaka (JP)

(72) Inventor: Satoru TOMOSHI, Osaka (JP)

(73) Assignee: Keyence Corporation, Osaka (JP)

(21) Appl. No.: 18/785,058

(22) Filed: Jul. 26, 2024

(30) Foreign Application Priority Data
Sep. 25, 2023 (JP) 2023-159388

(51) Int. Cl. G01F 23/284; G01F 23/80; G01F 25/20

(52) U.S. Cl. CPC G01F 23/2845; G01F 23/804; G01F 25/20

(57) ABSTRACT

Provided is a level meter that allows a user to easily visually grasp a relative position of a threshold with respect to a container when the user sets a threshold of a level. The display portion of the level meter displays a bar display whose length expands and contracts according to the value of the level of the object stored in the container. In addition, the display portion displays a relative position of the plurality of level setting values related to the level with respect to the container together with the bar display.

### CROSS-REFERENCE TO RELATED APPLICATIONS

The present application claims foreign priority based on Japanese Patent Application No. 2023-159388, filed Sep. 25, 2023, the contents of which are incorporated herein by reference.

### BACKGROUND OF THE INVENTION

### 1. Technical Field

The present invention relates to a level meter that measures a level of an object.

### 2. Description of the Related Art

In a container that stores a flowable substance such as a liquid, a powder, or a granular material, a level meter that measures a height of an interface of the substance, that is, a level (liquid level, powder upper surface level, etc.) may be used. Such a level meter has a function of defining measurement conditions, that is, a function of setting conditions under which the level is measured.

For example, a level meter described in Patent Literature 1 includes a setting mode for determining a value of a parameter for defining a measurement condition.

In a conventional level meter, values of parameters for defining measurement conditions are displayed as characters and numerical values. For example, a level meter disclosed in JP 2014-002091 A is provided with a display portion, and in each setting mode, parameters that can be set are displayed on the display portion as character strings and numerical values.

However, it is difficult for the user to visually grasp the relationship between the parameter and the container only by displaying the parameter as a character string and a numerical value. For example, in a case where a threshold for output determination is set in the setting mode, the user needs to calculate and determine how much the threshold is a relative position to the entire container (or a ratio to the full capacity value) on the basis of the displayed numerical value and the capacity of the container. That is, the user cannot visually grasp how much the threshold corresponds to the relative position to the container only by looking at the numerical value of the threshold displayed in the setting mode.

### SUMMARY OF THE INVENTION

In view of the above problems, it is an object of the present invention to provide a level meter with which a user can easily visually grasp a relative position of the level setting value related to the level with respect to the container.

In order to solve the above problem, a level meter as an example of an embodiment according to the present invention is a level meter installed in an upper part of a container toward a bottom of the container to measure a level of an object stored in the container, the level meter including: a transmission/reception unit including a transmission circuit that transmits a measurement signal for measuring the level, and a reception circuit that receives a reflection signal due to reflection of the measurement signal by the object; a level determination unit that determines the level based on the reflection signal received by the reception circuit and container information on the container; a setting unit that sequentially sets the container information and a plurality of level setting values related to the level determined by the level determination unit; and a display portion that displays, based on the level determined by the level determination unit, the container information, and the level setting value, a relative position of the level setting value with respect to the container together with a bar display in which a length expands and contracts according to a value of the level determined by the level determination unit.

According to the present invention, the user can easily visually grasp the relative position of the level setting value related to the level with respect to the container by confirming the display portion.

### BRIEF DESCRIPTION OF THE DRAWINGS

FIG. 1 is a perspective view illustrating a level meter;

FIG. 2 is a cross-sectional view of the level meter;

FIG. 3 is a view illustrating a state in which the level meter is attached to a container that contains an object;

FIG. 4 is a block diagram schematically illustrating an example of a relationship between components of the level meter;

FIG. 5 is a view illustrating an example of a configuration of a radar control unit and a transmission/reception unit;

FIG. 6 is a view illustrating a relationship between a measurement signal and a reflection signal;

FIG. 7 is a view illustrating a state transition of the level meter;

FIG. 8 is a view illustrating screen transition of a display portion in initial setting;

FIG. 9 is a view illustrating screen transition of the display portion in operation setting;

FIG. 10 is a view illustrating screen transition of the display portion in scaling setting;

FIG. 11 is a view illustrating a language setting screen;

FIG. 12 is a view illustrating a setup start confirmation screen;

FIG. 13 is a view illustrating a distance measurement value confirmation screen;

FIG. 14 is a view illustrating an input/output setting screen;

FIG. 15 is a view illustrating a distance unit setting screen;

FIG. 16 is a view illustrating a scaling confirmation screen;

FIG. 17 is a view illustrating a bottom distance setting screen;

FIG. 18 is a view illustrating an upper surface distance setting screen;

FIG. 19 is a view illustrating a first threshold setting screen;

FIG. 20 is a view illustrating an output logic setting screen for a first threshold;

FIG. 21 is a view illustrating a second threshold setting screen;

FIG. 22 is a view illustrating an indicator lamp pattern setting screen;

FIG. 23 is a view illustrating a change in the indicator lamp pattern setting screen using animation;

FIG. 24 is a view illustrating a second indicator lamp pattern;

FIG. 25 is a view illustrating a setup completion confirmation screen;

FIG. 26 is a view illustrating a display value setting screen;

FIG. 27 is a view illustrating a decimal point position setting screen;

FIG. 28 is a view illustrating a tank shape setting screen;

FIG. 29 is a view illustrating a capacity setting screen;

FIG. 30 is a view illustrating an option of a spherical tank;

FIG. 31 is a view illustrating a bottom distance setting screen of the spherical tank;

FIG. 32 is a view illustrating an upper surface distance setting screen of the spherical tank;

FIG. 33 is a view illustrating a capacity setting screen of the spherical tank;

FIG. 34 is a view illustrating an option of a horizontal cylindrical tank;

FIG. 35 is a view illustrating an option of a conical bottom tank;

FIG. 36 is a view illustrating a bottom height setting screen of the conical bottom tank;

FIG. 37 is a view illustrating an option of a quadrangular pyramid bottom tank;

FIG. 38 is a view illustrating an option of an inclined bottom tank;

FIG. 39 is a view illustrating an option of multipoint correction;

FIG. 40 is a view illustrating a multipoint correction screen of multipoint correction;

FIG. 41 is a view illustrating an example of a tank shape corresponding to multipoint correction;

FIG. 42 is a view illustrating a display portion in a measurement mode;

FIG. 43 is a view illustrating a menu screen;

FIG. 44 is a view illustrating a miscellaneous setting screen;

FIG. 45 is a view illustrating an input/output setting screen transitioned from the miscellaneous setting screen;

FIG. 46 is a perspective view illustrating another example of the level meter;

FIG. 47 is a cross-sectional view of another example of the level meter;

FIG. 48 is a view illustrating another example of the bottom distance setting screen;

FIG. 49 is a view illustrating another example of a second threshold setting screen;

FIG. 50 is a view illustrating another example of the output logic setting screen of the second threshold;

FIG. 51 is a view illustrating another example of an indicator lamp pattern setting screen;

FIG. 52 is a view illustrating another example of a setup completion confirmation screen; and

FIG. 53 is a perspective view illustrating still another example of the level meter.

### DETAILED DESCRIPTION

Hereinafter, embodiments of the present invention will be described with reference to the drawings. Note that, in the drawings, the same or corresponding portions are denoted by the same reference numerals, and the description thereof will not be basically repeated. In addition, in the following description, terms meaning positions or directions such as front, back, left, right, upper, and lower may be used, but these terms are used for convenience to facilitate understanding of the embodiments. These terms are not limited to front, back, left, right, top, bottom, etc., in a geometrically strict sense unless expressly stated otherwise.

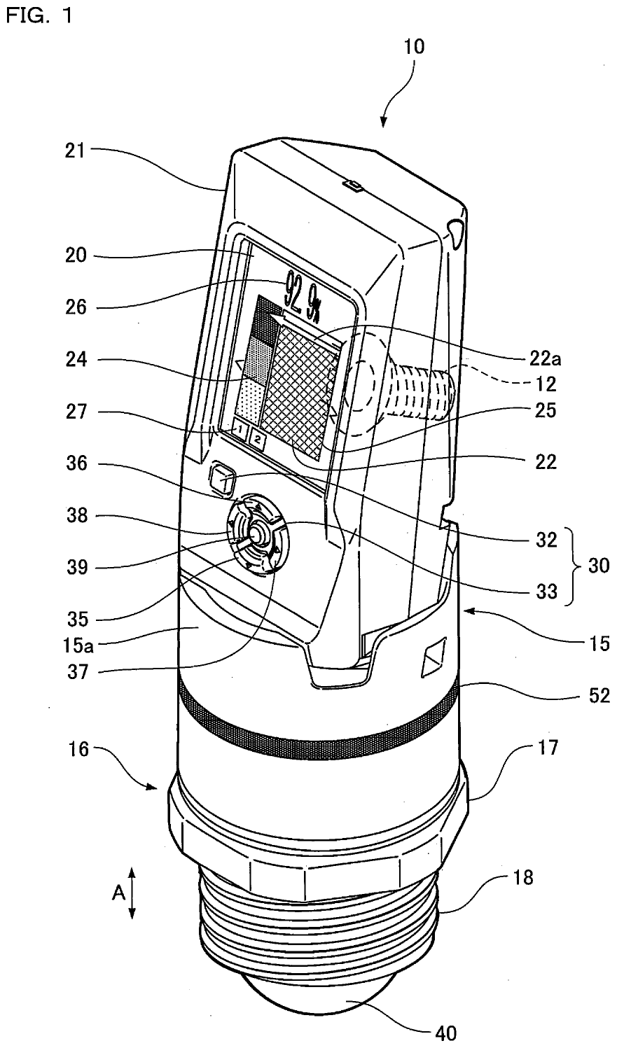

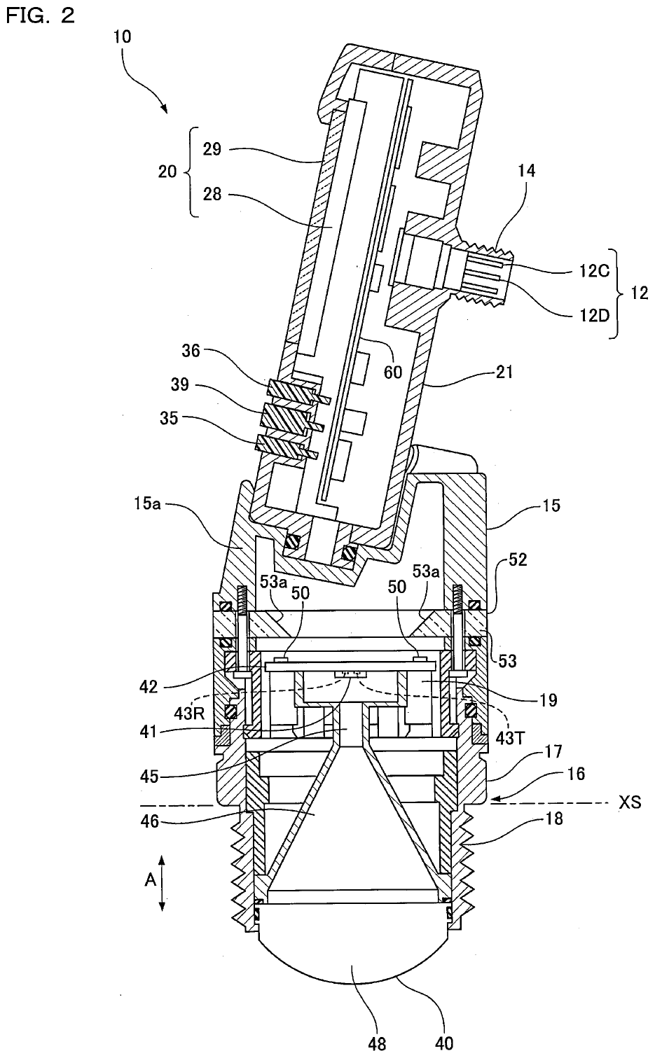

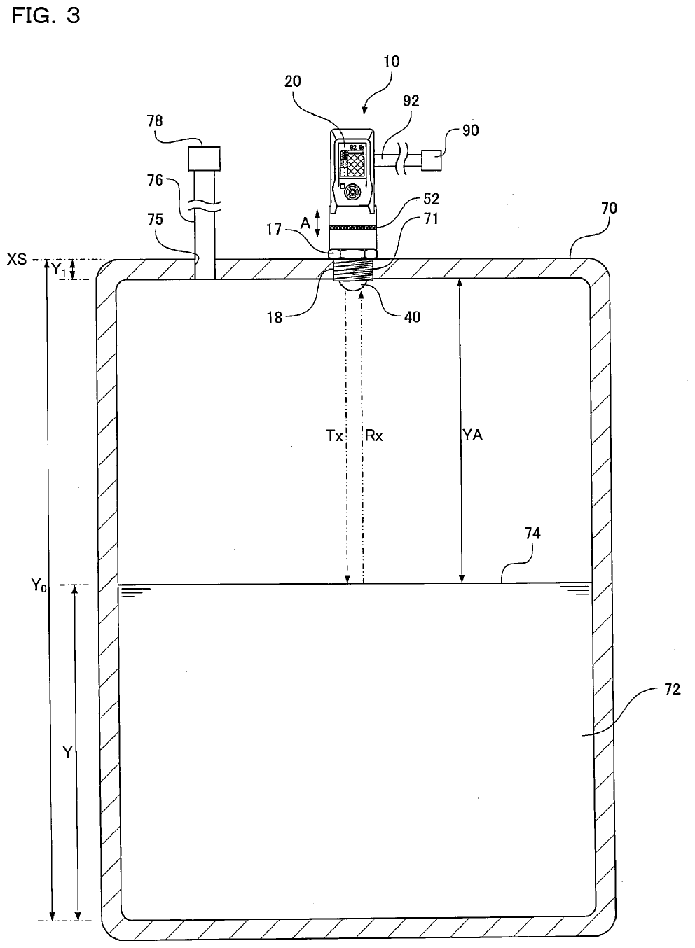

Hereinafter, a level meter 10 as an example of an embodiment according to the present invention will be described with reference to the drawings. First, an example of a structure and a use state of the level meter 10 will be described with reference to FIGS. 1, 2, and 3. In FIG. 1, a perspective view of the level meter 10 of the present embodiment is illustrated. FIG. 2 illustrates a cross-sectional view of the level meter 10 of FIG. 1. FIG. 3 illustrates a state in which the level meter 10 is attached to a container 70 (for example, a tank) that stores an object 72.

The level meter 10 is a device that measures a level Y of the object 72 to be measured (for example, liquid, powder, granular material, and the like). The measured level Y is the height of an interface 74 of the object 72 in the container 70. Specific examples of the level Y include the distance from the bottom of the container 70 to the liquid level of the liquid contained in the container 70. A measurement axis is set in the level meter 10, and the level meter 10 measures the level Y along the measurement axis.

As an example of the use state of the level meter 10, the container 70 of FIG. 3 stores, for example, a liquid (water, oil, chemical solution, and the like) as the object 72 in a liquid treatment facility. For example, when the object 72 in the container 70 is supplied to a liquid treatment process or the like, the level Y of the object 72 in the container 70 decreases. In addition, as the container 70 is replenished with the object 72, the level Y of the object 72 in the container 70 increases. For example, a water injection port 75 is provided in an outer wall (an upper wall in FIG. 3) of the container 70. A water injection pipe 76 is fluidly connected to the container 70 via the water injection port 75. Then, the water injection pipe 76 is connected to a water injection device 78 (device including, for example, a pump, a valve or the like) provided outside the container 70. The water injection device 78 is a device for supplying (injecting) the object 72 into the container 70 from the outside of the container 70. The water injection device 78 adjusts the amount of water injected into the container 70 according to the level Y of the object 72 in the container 70. In addition, the water injection device 78 stops the water injection depending on the level Y of the object 72 in the container 70. The water injection device 78 controls the replenishment of the object 72 to the container 70 according to the level Y of the object 72 in the container 70 such that the level Y of the object 72 in the container 70, which decreases as the object 72 is consumed, for example, by the liquid treatment process, falls within a predetermined range.

The level meter 10 in FIG. 1 has a housing 15 including a base 15a and a terminal 21. The base 15a is disposed on one end side (lower side) in the longitudinal direction A (the direction of the measurement axis) in the housing 15. The terminal 21 is disposed on the other end side in the longitudinal direction A. In FIG. 1, a display portion 20 is provided in the terminal 21. In addition, the terminal 21 can be separated from the base 15a. The base 15a has a cylindrical shape, while the terminal 21 has a prismatic shape.

The terminal 21 may be fixed to the base 15a by a fastening screw on the back surface side with respect to the display portion 20. In addition, a connection connector that transmits an electric signal between the base 15a and the terminal 21 is preferably provided. For example, one of the pair of connection connectors may be provided on the base 15a, and the other of the pair of connection connectors may be provided on the terminal 21. Connecting the pair of connection connectors enables transmission and reception of an electric signal between the base 15a and the terminal 21.

A sensor unit 16 is disposed on one end side (lower side in FIG. 1) in the longitudinal direction A of the housing 15. Hereinafter, one end (lower end) of the sensor unit 16 in the longitudinal direction A is referred to as a measurement end 40. As illustrated in FIG. 2, a dielectric lens 48 is disposed at the measurement end 40. Hereinafter, one end side of the level meter 10 in the longitudinal direction A may be referred to as a lower side, and the other end side in the longitudinal direction A may be referred to as an upper side.

As illustrated in FIG. 3, the sensor unit 16 of FIG. 1 measures the level Y of the object 72 in a state where one end in the longitudinal direction A is directed to the object 72. For example, in a case where the level meter 10 measures the height (interface 74) of the liquid, the longitudinal direction A of the level meter 10 faces the same direction as the change direction of the height of the liquid level of the liquid, that is, the vertical direction (height direction, gravitation direction).

The level meter 10 in FIG. 3 transmits a radio wave to be the measurement signal Tx from the measurement end 40 toward the object 72. Then, a reflection signal Rx obtained by reflecting the measurement signal Tx at the interface 74 of the object 72 is received by the measurement end 40. The level meter 10 calculates the level Y of the object 72 based on the measurement signal Tx and the reflection signal Rx. For example, in the case of performing the measurement using the time of flight (ToF) method, the level meter 10 calculates a distance YA from the measurement end 40 to the interface 74 based on the difference between the measurement signal Tx and the reflection signal Rx, and calculates the level Y based on the distance YA. In addition, for example, in a case where measurement is performed by a radar method using a frequency modulated continuous wave (FMCW), the level meter 10 calculates the distance YA from the measurement end 40 to the interface 74 based on a frequency of a waveform obtained by mixing the measurement signal Tx and the reflection signal Rx, and calculates the level Y based on the distance YA.

As illustrated in FIG. 1, an attachment screw 18 in which a thread is engraved on the surface of the cylinder is provided above the measurement end 40 in the sensor unit 16. An attachment portion 17 having a diameter larger than that of the attachment screw 18 is provided above the attachment screw 18. The attachment portion 17 in FIG. 1 has a nut shape. Note that the attachment portion 17 is not limited to a nut shape as long as it has a structure capable of attaching the level meter 10 to an attachment target (such as a container 70 that stores liquid). For example, the attachment portion 17 may have a cylindrical shape in which an anti-slip projection is formed. The anti-slip projection of the attachment portion 17 serves as an anti-slip portion when the level meter 10 is attached or detached (rotationally attached or detached) while rotating around the longitudinal direction A with respect to the attachment target. In addition, an attachment flange for attaching the level meter 10 to an attachment target may be formed instead of the attachment portion 17 and the attachment screw 18. In addition, even in a case where the attachment flange is formed, the attachment portion 17 and the attachment screw 18 may be provided in addition to the attachment flange.

The level meter 10 in FIG. 3 is attached to the upper side of the container 70. An attachment hole 71 is provided above the container 70. The attachment hole 71 is a screw hole, and the attachment screw 18 of the level meter 10 is screwed into the attachment hole 71, whereby the level meter 10 is attached to the container 70. For example, the user of the level meter 10 can screw the attachment screw 18 into the attachment hole 71 by rotating the nut-shaped attachment portion 17 with the leading end of the attachment screw 18 aligned with the attachment hole 71. Note that the structure for attaching the level meter 10 to the container 70 is not limited thereto. For example, the attachment hole 71 is not threaded, and a nut is separately screwed to the attachment screw 18 exposed to the inside of the container 70, whereby the level meter 10 may be attached to the container 70. In addition, the level meter 10 may be attached to a mounting bracket which is provided above the container 70 with an upper surface of the container 70 opened by using a nut and the attachment screw 18. In addition, the method of attaching the level meter 10 to the container 70 is not limited to the screwing using the attachment screw 18, and the thread may not be formed on the outer peripheral surface of the sensor unit 16. For example, a flange may be provided on one or both of the level meter 10 and the container 70, and the level meter 10 may be attached to the container 70 by fixing the flange to the level meter 10 or the container 70 with a bolt.

The display portion 20 is provided on the surface of the terminal 21 disposed on the upper side of the housing 15. The display portion 20 preferably includes an active matrix type display device (active matrix display) capable of displaying various types of information. For example, the display portion 20 includes a liquid crystal display (LCD). In particular, the display portion 20 preferably includes an LCD capable of color display (display with a plurality of colors).

The display portion 20 may be a two-wire reflective color liquid crystal display that performs both power transmission and reception and data communication by two power lines. The two-wire display performs data communication by varying the magnitude of the current transmitted through the power line. For example, the consumption current of the power line varies in the range of 4 to 20 mA. The content of the data to be transmitted and received is represented by the magnitude of the consumption current. In addition, the reflective display allows the user to visually recognize the display content by external light reflected on the surface thereof. Although a two-wire display can use small power consumption, a two-wire reflective color liquid crystal display can perform various displays with small power consumption.

The display portion 20 displays the level Y of the object 72 measured by the sensor unit 16. In FIGS. 1 and 3, a bar display 22 whose length expands and contracts according to the value of the level Y is displayed on the display portion 20. In addition, the display portion 20 also displays a color gauge 24 (example of a gauge) color-coded with a plurality of colors. The length direction of the color gauge 24 is arranged along the expansion/contraction direction of the bar display 22. The color gauge 24 includes a plurality of (three in FIG. 1) sections arranged along the expansion/contraction direction of the bar display 22. The section of the color gauge 24 corresponds to a plurality of level ranges set with respect to the level Y of the object 72, and the level range is defined by a plurality of level setting values (for example, thresholds) set with respect to the level Y.

The display portion 20 displays the relative position of the level Y with respect to the container 70 storing the object 72 together with the bar display 22. Specifically, the bar display 22 expands and contracts in length according to the value of the level Y of the object 72 in a container icon 25 imitating the container 70. The length of the bar display 22 with respect to the size of the container icon 25 corresponds to the relative position of the level Y of the object 72 with respect to the entire container 70.

Then, a bar arrow 22a is displayed at a leading end (upper end) in the expansion/contraction direction of the bar display 22. The bar arrow 22a indicates a position in the color gauge 24 corresponding to the length of the bar display 22. The color gauge 24 indicates to which level range the measured level Y belongs among the plurality of level ranges defined by the level setting value.

The color gauge 24 includes a plurality of sections. The plurality of sections of the color gauge 24 are divided into a plurality of level ranges. Then, the plurality of sections of the color gauge 24 are arranged along the increasing/decreasing direction of the level Y in the display portion 20. The container icon 25 and the bar display 22 are displayed next to the color gauge 24 (side by side with the color gauge 24). Since the color gauge 24 is displayed side by side with the container icon 25 and the bar display 22 in the display portion 20, the relative position of the level setting value with respect to the container 70 is displayed together with the bar display 22.

In addition, an auxiliary display portion 26 indicating information other than the bar display 22 and the color gauge 24 is also displayed on the display portion 20. In FIG. 1, the measured level Y is displayed as a ratio value (percentage of full capacity value, % display) in the auxiliary display portion 26.

In addition, the display portion 20 also displays an output state display portion 27. The output state display portion 27 displays the state of the signal line whose output changes depending on the relationship between the measured level Y and the level setting value. For example, when a signal is transmitted from a specific signal line in a case where the level Y exceeds a threshold determined as a level setting value, a number corresponding to the signal line is displayed in the output state display portion 27. For example, in FIG. 1, the bar arrow 22a indicates the uppermost section among the three sections of the color gauge 24. This state of the display portion 20 indicates that two thresholds are set as the level setting value, and the measured level Y exceeds both of the two thresholds.

Then, when a signal line that outputs a signal in a case where the measured level Y exceeds the threshold is prepared, signals are output from two signal lines corresponding to the two thresholds in the state of FIG. 1. In FIG. 1, in order to indicate that signals are output from two signal lines, numbers (here, “1” and “2”) corresponding to the two signal lines that output signals are displayed on the output state display portion 27.

In addition, an operation unit 30 is also disposed on the same surface of the terminal 21 as the outer surface on which the display portion 20 is disposed. The operation unit 30 in FIG. 1 is disposed below the display portion 20. The operation unit 30 includes a menu key 32 and a direction key 33. In addition, the direction key 33 includes an up key 36 (up key) and a down key 35 (down key) arranged along the longitudinal direction A. In addition, the direction key 33 includes a left key 38 (left key) and a right key 37 (right key) arranged in a direction intersecting the longitudinal direction A. Further, a center key 39 (center key) is provided at a position surrounded by the up key 36, the down key 35, the left key 38, and the right key 37 in the direction key 33.

The user of the level meter 10 can change the operation parameter of the level meter 10 by operating the operation unit 30. In particular, the user can change the level setting values related to the display content and the level range of the display portion 20 by operating the operation unit 30. In addition, the user can change the display format of the level Y displayed on the auxiliary display portion 26 by changing the display content of the display portion 20. For example, the user can change the level Y displayed as a ratio in FIG. 1 to be displayed as a length value (for example, mm: millimeter value). For example, the display format of the level Y may be switched each time the user operates the left key 38 or the right key 37.

A connection portion 12 is provided on a back surface (a portion opposite to the display portion 20) of the terminal 21. As illustrated in FIGS. 1 and 2, the connection portion 12 has a cylindrical shape protruding from the back surface of the terminal 21. An outer peripheral surface of the cylindrical connection portion 12 is a connection screw portion 14 in which a thread is cut. As illustrated in FIG. 2, the connection portion 12 includes an external input terminal 12C and an external output terminal 12D. The external input terminal 12C is a terminal for inputting a signal or power, or both, from the outside to the level meter 10. The external output terminal 12D is a terminal for outputting a signal from the level meter 10 to the outside. Each of the external input terminal 12C and the external output terminal 12D may include a plurality of signal lines or a plurality of terminals. For example, signals may be output from different signal lines or different output terminals to the outside according to the level range to which the measured level Y belongs.

A connection cable 92 illustrated in FIG. 3 is connected to the connection portion 12. The connection cable 92 connects a management device 90 (such as a programmable controller) provided outside the container 70 and the level meter 10. A signal indicating the level Y of the object 72 measured by the level meter 10 is transmitted (output) to the management device 90 through the external output terminal 12D (a part of output unit 66 to be described later) of the connection portion 12 and the connection cable 92. The management device 90 manages the operation of the entire facility including the container 70 based on the signal received from the level meter 10.

As illustrated in FIG. 1, an indicator lamp 52 is provided on an outer peripheral surface of the base 15a connected to a lower side of the terminal 21. The lighting state of the indicator lamp 52 changes according to the measured level Y of the object 72. The user can roughly know the state of the object 72 by visually observing the lighting state of the indicator lamp 52. In FIG. 1, the indicator lamp 52 is disposed between the terminal 21 and the sensor unit 16. The indicator lamp 52 can emit light in various lighting colors (for example, green, yellow, red, and the like). The indicator lamp 52 preferably emits light in a lighting color corresponding to the level range to which the level Y measured by the level meter 10 belongs. For example, the indicator lamp 52 may emit light in the same color as the color of the section indicated by the bar arrow 22a among the color gauges 24 color-coded by a plurality of colors for each section.

As illustrated in the cross-sectional view of FIG. 2, a sensor IC 41 (IC: Integrated Circuit) and a sensor board 42 that supports the sensor IC 41 are disposed inside the sensor unit 16 on the lower side of the base 15a. The sensor IC 41 performs transmission and reception of radio waves and signal processing for measuring the level Y of the object 72. The signal processed by the sensor IC 41 is transmitted to a display board 60 provided in the terminal 21.

As the sensor IC 41, for example, an MMIC (Monolithic Microwave Integrated Circuit) is used. The MMIC is an IC in which a plurality of semiconductor components that perform transmission of radio waves, reception of radio waves, signal processing based on transmitted and received radio waves, and the like are integrated into a single semiconductor device (one chip). In the sensor IC 41 of FIG. 2, an antenna is integrated with the MMIC by using an antenna in package (AiP) technology or an antenna on package (AoP) technology. That is, in FIG. 2, the sensor IC 41 is an antenna-integrated package (antenna on package) in which a transmission circuit 43T that transmits a radio wave and a reception circuit 43R that receives a radio wave are integrated in a single semiconductor device. Since the antenna-integrated MMIC is used as the sensor IC 41, the volume occupied by the configuration for transmitting and receiving radio waves is reduced, and the entire dimension of the level meter 10 becomes compact. Note that the sensor IC 41 is not limited to the antenna-integrated MMIC alone, and may include a plurality of ICs. The sensor IC 41 may include, for example, an MMIC and a microcomputer. Then, the antenna-integrated MMIC may include a radio wave transmission antenna, a radio wave reception antenna, and a circuit that executes radio wave transmission/reception control, and the microcomputer may include a circuit that executes signal processing or arithmetic processing based on a reception signal received from the antenna-integrated MMIC.

The sensor IC 41 is mounted on the lower surface of the sensor board 42. The sensor board 42 is an electronic circuit board in which various electronic circuit elements are arranged on a plate made of an insulator such as glass or resin. In FIG. 2, the sensor board 42 is disposed in a direction orthogonal to the longitudinal direction A (horizontal direction in FIG. 2).

The measurement end 40 is located below the sensor board 42. The measurement end 40 of FIG. 2 includes a waveguide 45, a horn antenna 46, and a dielectric lens 48 as internal structures. In a case where the sensor IC 41 is an antenna-integrated MMIC, a radio wave serving as the measurement signal Tx is transmitted from the transmission circuit 43T of the sensor IC 41. The measurement signal Tx transmitted from the sensor IC 41 is guided toward the object 72 through the waveguide 45, the horn antenna 46, and the dielectric lens 48 in this order. In addition, the reflection signal Rx reflected by the object 72 and incident on the measurement end 40 is guided toward the reception circuit 43R of the sensor IC 41 through the dielectric lens 48, the horn antenna 46, and the waveguide 45 in this order.

The waveguide 45, the horn antenna 46, and the dielectric lens 48 arranged inside the sensor unit 16 guide the traveling direction of the radio wave the radio wave in the longitudinal direction A, and thus they exhibit strong directivity with respect to the radio wave as a whole by combining them. Therefore, the sensor unit 16 can appropriately guide the measurement signal Tx and the reflection signal Rx even if the length direction dimension (length along the longitudinal direction A) is small. In addition, by appropriately guiding the measurement signal Tx and the reflection signal Rx, the transmission of the measurement signal Tx and the reception of the reflection signal Rx can be performed by the common measurement end 40 even though the position of the transmission circuit 43T and the position of the reception circuit 43R are different in the sensor IC 41. Therefore, by using the waveguide 45, the horn antenna 46, and the dielectric lens 48, the designer of the level meter 10 can reduce the dimension in the length direction of the level meter 10 including the sensor unit 16, and the dimension of the entire level meter 10 can be made compact.

On the other hand, a rotation mechanism 19 is provided inside the base 15a disposed above the sensor unit 16. The rotation mechanism 19 in FIG. 2 is disposed at a lower end (one end in the longitudinal direction A) of the housing 15, that is, between the housing 15 and the sensor unit 16. The rotation mechanism 19 can relatively rotate the base 15a and the terminal 21 connected to the base 15a with respect to the sensor unit 16. The rotation mechanism 19 is disposed such that the rotation axis is parallel to the longitudinal direction A. Since the rotation mechanism 19 is provided, the user can turn the display portion 20 in a direction in which it is easy to view by rotating the housing 15. In particular, when the level meter 10 is attached to the container 70 (such as a tank) including the object 72 by the attachment screw 18, the user can direct the display portion 20 in a direction in which the user can easily see the display portion 20 without moving the entire level meter 10.

The display board 60 is disposed inside the terminal 21. The display board 60 is an electronic circuit board in which various electronic circuit elements are arranged on a plate made of an insulator such as glass or resin. A signal processing circuit for controlling the display portion 20 is mounted on the display board 60. The display board 60 receives a signal from the sensor IC 41, and converts the level Y of the object 72 measured by the sensor unit 16 into a signal for displaying the level in the display portion 20. The display board 60 of FIG. 2 is disposed on the back side of the display portion 20 (inside the housing 15 in FIG. 2).

The display portion 20 in FIG. 2 includes a display device 28 and a transparent display window 29. The display device 28 is, for example, an LCD, particularly an LCD capable of color display. The display window 29 is, for example, a plate made of an optically transparent material such as glass, acrylic, polyarylate, or polycarbonate, and optically transmits the display content of the display device 28 to the outside of the housing 15.

The indicator lamp 52 provided between the terminal 21 and the sensor unit 16 includes a plurality of state LEDs 50 (Light Emitting Diodes (LEDs)) and a transmission window 53. The plurality of state LEDs 50 are arranged on the upper side of the sensor board 42, that is, on the surface opposite to the sensor IC 41. The transmission window 53 of the indicator lamp 52 is disposed on the outer peripheral surface above the state LED 50. The transmission window 53 disposed on the outer peripheral surface of the base 15a has a surface along the longitudinal direction A (a surface in the vertical direction) facing the outside of the housing 15. The light emitted from the state LED 50 is guided to the outside of the housing 15 through the transmission window 53 including a member that diffuses the light. Here, the member that diffuses the light included in the transmission window 53 may have a donut-shaped disk shape. In addition, it is preferable that a tapered surface 53a having a tapered shape is formed on the inner peripheral side surface of the donut shape of the member that diffuses light. When the tapered surface 53a is formed on the inner peripheral side of the transmission window 53, the light emitted from the state LED 50 is reflected by the tapered surface 53a and is reliably guided to the outside of the housing 15.

The lighting state of the state LED 50 changes according to the level Y of the object 72 measured by the sensor unit 16. The light emitted from the state LED 50 is guided to the outside of the housing 15 through the transmission window 53. Therefore, as the lighting state of the state LED 50 changes according to the level Y of the object 72, the lighting state of the indicator lamp 52 changes. In addition, since the transmission window 53 includes a member that diffuses light, the light emitted from the state LED 50 is diffused in a direction intersecting the longitudinal direction A. Therefore, the user can easily visually grasp the lighting state of the indicator lamp 52 from a long distance.

The state LED 50 may emit light in a single color (for example, red, yellow, green, and the like) or may emit light by switching a plurality of colors (for example, red, yellow, green, and the like). When the state LED 50 emits light by switching a plurality of colors, a plurality of light emitting elements that emit light in different colors may be included in one LED, or a combination of a plurality of LEDs that emit light in different colors may be arranged as the state LED 50. Then, the state LED 50 may emit light by mixing a plurality of colors. In addition, when the state LED 50 emits light by switching a plurality of colors, the state LED 50 may emit light in a color corresponding to the color of the section of the color gauge 24 corresponding to the level range to which the measured level Y belongs.

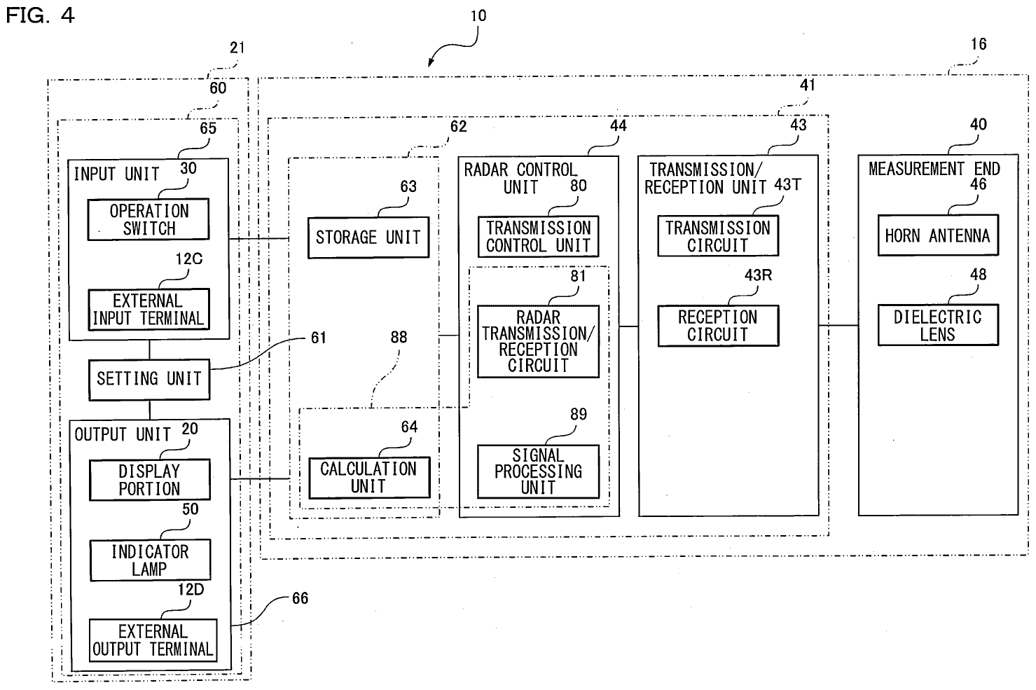

Next, a relationship between the components of the level meter 10 will be described with reference to FIG. 4. FIG. 4 is a block diagram schematically illustrating an example of a relationship between the components of the level meter 10. As illustrated in FIG. 4, the sensor IC 41 of the sensor unit 16 includes a transmission/reception unit 43, a radar control unit 44, and a processing unit 62. The transmission/reception unit 43 includes a transmission circuit 43T that transmits the measurement signal Tx and a reception circuit 43R that receives the reflection signal Rx. The sensor IC 41 may include a plurality of ICs. For example, the sensor IC 41 may include an antenna-integrated MMIC and a microcomputer.

The radar control unit 44 includes a transmission control unit 80 that determines the waveform of the measurement signal Tx, a radar transmission/reception circuit 81 that performs mutual conversion between a digital signal and a radio wave, and a signal processing unit 89 that performs signal processing based on the measurement signal Tx and the reflection signal Rx. Further, in a case where the sensor IC 41 includes the antenna-integrated MMIC and the microcomputer, the antenna-integrated MMIC may include a portion (the transmission control unit 80 and the radar transmission/reception circuit 81) of the radar control unit 44 excluding the signal processing unit 89 and the transmission/reception unit 43, and the microcomputer may include the signal processing unit 89 and the processing unit 62.

The processing unit 62 includes a storage unit 63 and a calculation unit 64. The storage unit 63 stores various setting values (data) related to the operation of the level meter 10. The calculation unit 64 performs various calculations relating to the operation of the level meter 10 based on the setting values stored in the storage unit 63, the signal processing result of the signal processing unit 89, and the like. The storage unit 63 includes a storage device such as a random access memory (RAM) and a read only memory (ROM). The calculation unit 64 includes a processor such as a central processing unit (CPU). Note that the storage unit 63 and the calculation unit 64 may be provided on the display board 60 of the housing 15. Alternatively, the storage units 63 and the calculation units 64 may be separately provided in the sensor unit 16 and the housing 15, respectively, and stored data and responsible arithmetic processing may be shared by the sensor unit 16 and the housing 15. As illustrated in FIG. 4, the calculation unit 64, the radar transmission/reception circuit 81 of the radar control unit 44, and the signal processing unit 89 together function as a level determination unit 88. The level determination unit 88 performs processing of determining the level Y on the basis of the reflection signal Rx received by the reception circuit 43R and the container information regarding the container 70 (for example, the height of the container 70).

On the other hand, the display board 60 of the terminal 21 includes a setting unit 61, an input unit 65, and an output unit 66. The setting unit 61 performs processing of sequentially setting the container information regarding the container 70 and a plurality of level setting values regarding the level Y. The input unit 65 is an interface circuit that inputs an input provided from the outside of the level meter 10 to the level meter 10 as a signal. The input provided from the outside of the level meter 10 is, for example, a user's operation on the operation unit 30, a control signal provided from an external device (such as the management device 90 or the like) via the external input terminal 12C, and the like. The input unit 65 causes the storage unit 63 to store, for example, flag information indicating that the operation unit 30 has been operated, and data such as a setting value provided via the external input terminal 12C.

The output unit 66 is an interface circuit that outputs a signal generated inside the level meter 10 to the outside. The output unit 66 changes, for example, the display content of the display portion 20, the lighting state of the indicator lamp 52, and the like according to the calculation result (such as the value of the level Y) by the calculation unit 64. In addition, the output unit 66 transmits the calculation result by the calculation unit 64 to an external device via the external output terminal 12D.

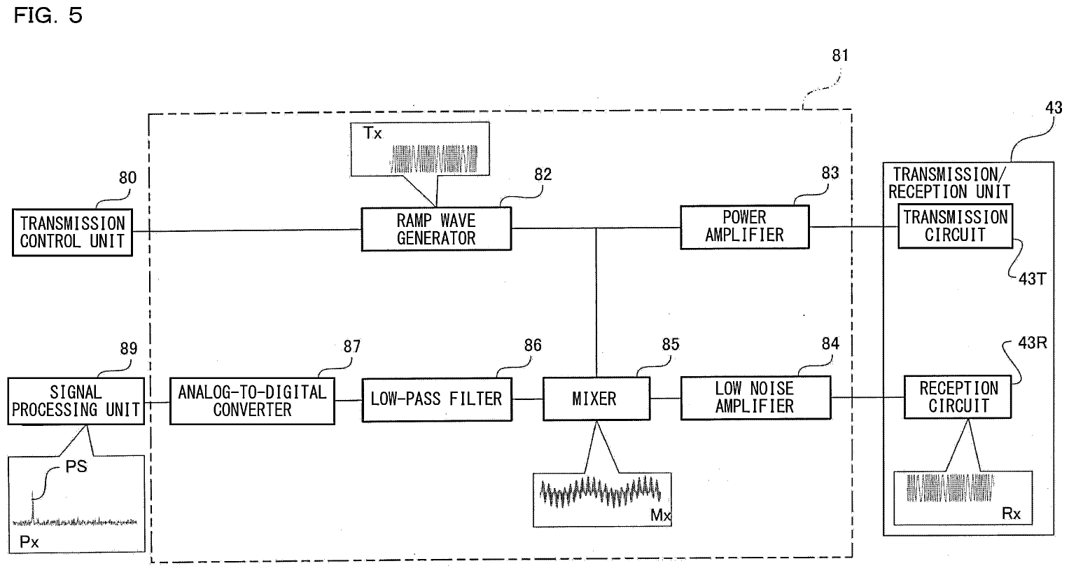

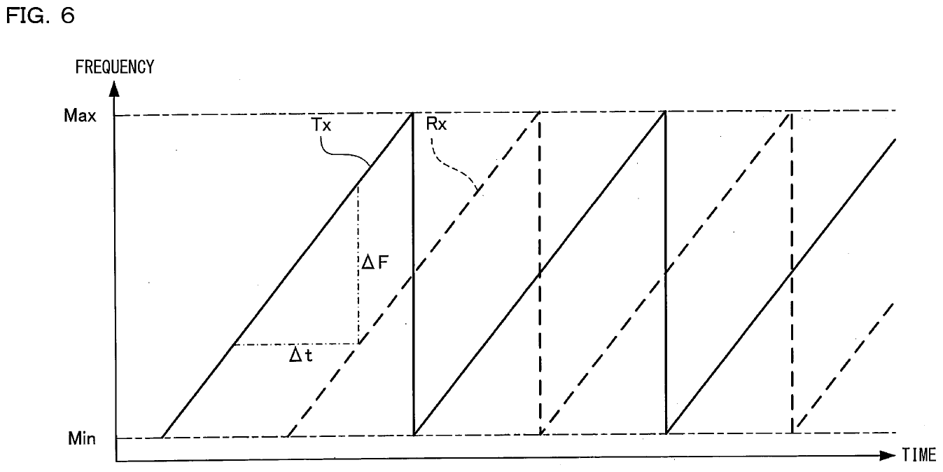

The measurement of the level Y by the level meter 10 will be described in more detail with reference to FIGS. 5 and 6. FIG. 5 is a view illustrating an example of configurations of the radar transmission/reception circuit 81 and the transmission/reception unit 43 included in the sensor IC 41. FIG. 6 is a view illustrating a relationship between the measurement signal Tx and the reflection signal Rx.

As illustrated in FIG. 5, the radar transmission/reception circuit 81 includes a ramp wave generator 82, a power amplifier 83, a low noise amplifier 84, a mixer 85, a low-pass filter 86, and an analog-to-digital converter 87.

The level meter 10 of the present embodiment measures the level Y by a radar method using FMCW. The ramp wave generator 82 is connected to the transmission control unit 80. When receiving data indicating the waveform of the measurement signal Tx determined by the transmission control unit 80, the ramp wave generator 82 generates a signal having the waveform according to the data. Here, as the waveform of the measurement signal Tx, a waveform that repeats increase and decrease in frequency is used.

FIG. 6 is a graph illustrating a change in frequency of the measurement signal Tx (and the reflection signal Rx) with respect to time. In FIG. 6, the frequency of the measurement signal Tx increases linearly with time from a minimum value (Min), and returns to the minimum value again when reaching a maximum value (Max). In this manner, the frequency of the measurement signal Tx repeatedly increases and decreases. Note that the frequency increase/decrease pattern is not limited to this, and it is sufficient that the level determination unit 88 can calculate the level Y on the basis of the comparison between the measurement signal Tx and the reflection signal Rx. For example, a pattern that decreases linearly from the maximum value with time and returns to the maximum value again when reaching the minimum value may be used. In addition, a pattern of repeating linear increase/decrease and decrease between the maximum value and the minimum value may be used. The measurement signal Tx used in the present embodiment is a radio wave in the 60 GHz band, and the minimum value of the frequency is, for example, 58 GHz and the maximum value is, for example, 69 GHZ. The frequency band to be used is not limited thereto, and for example, a frequency of 77 GHz to 81 GHz may be used.

The signal generated by the ramp wave generator 82 in FIG. 5 is amplified by the power amplifier 83 and sent to the transmission circuit 43T. The transmission circuit 43T generates a radio wave having a waveform corresponding to the received signal and transmits the radio wave as the measurement signal Tx to the object 72. The measurement signal Tx is reflected by the interface 74 of the object 72 to become the reflection signal Rx, and is received as a reception signal by the reception circuit 43R. The reflection signal Rx is a wave having a phase shifted from that of the measurement signal Tx.

As indicated by a broken line in FIG. 6, the reflection signal Rx is a wave shifted from the measurement signal Tx by a time difference Δt. The time difference Δt is a value corresponding to the distance YA (FIG. 3) from the measurement end 40 to the interface 74 of the object 72. Since the reflection signal Rx reciprocates between the measurement end 40 and the object 72, there is a relationship of Δt=2×YA/c where c is the speed of light.

Then, a frequency difference ΔF corresponding to the magnitude of the time difference Δt is generated between the measurement signal Tx and the reflection signal Rx. There is a certain relationship between the frequency difference ΔF and the time difference Δt depending on the waveform of the measurement signal Tx. The waveform of the measurement signal Tx is a waveform whose frequency linearly changes with the lapse of time. That is, there is a certain relationship between the frequency difference ΔF and the time difference Δt according to the frequency change per unit time in the waveform of the measurement signal Tx. For example, the frequency of the measurement signal Tx increases linearly from the minimum value (Min) as time elapses, and reaches the maximum value (Max). In this case, the relationship between the frequency difference ΔF and the time difference Δt is uniquely determined by the difference between the maximum value and the minimum value of the frequency of the measurement signal Tx, which is the bandwidth of frequency modulation, and the relationship of the frequency change with time. Therefore, the level meter 10 can calculate the time difference Δt based on the frequency difference ΔF that is a difference between the measurement signal Tx and the reflection signal Rx. Then, the level meter 10 can calculate the distance YA (Δt×c/2) from the time difference Δt. Further, the level meter 10 can calculate the value of the level Y based on the distance YA. Specifically, the difference between the height of the container 70 (distance from the bottom of the container 70 to the upper surface inside the container 70) and the distance YA is the value of the level Y. Therefore, the level determination unit 88 can determine the level Y of the object 72 based on the reflection signal Rx received by the reception circuit 43R and the container information (such as the height of the container 70) on the container 70. Note that, as will be described in detail later, container information regarding the container 70, such as the height of the container 70, a bottom distance Y₀ from the level meter 10 to the bottom of the container 70, and an upper surface distance Y₁ from the level meter to the upper surface of the inside of the container 70 (the thickness of the top plate of the container 70 in FIG. 3), may be set in advance by the setting unit 61 before the measurement of the level Y is started. Note that the distance from the level meter 10 is, to be precise, a distance from a measurement reference surface XS (a plane on which the value of the distance is treated as 0) serving as a reference of measurement in the level meter 10. The position of the measurement reference surface XS is determined in advance before the use of the level meter 10 (for example, at the time of designing the level meter 10). For example, a position where the level meter 10 is attached to the container 70 (a position of an outer upper surface of the container 70 in FIG. 3) is determined as the measurement reference surface XS. In terms of the position in the level meter 10, the lower surface of the attachment portion 17 (the upper end of the attachment screw 18) is the measurement reference surface XS. In addition, since there is a certain relationship between the frequency difference ΔF and the time difference Δt depending on the waveform of the measurement signal Tx, the correspondence relationship between the frequency difference ΔF and the distance YA can be obtained in advance. The correspondence relationship between the frequency difference ΔF and the distance YA may be stored in advance in the storage unit 63.

As illustrated in FIG. 5, the reception signal corresponding to the reflection signal Rx received by the reception circuit 43R is input to the mixer 85 via the low noise amplifier 84. A signal corresponding to the waveform of the measurement signal Tx output from the ramp wave generator 82 is also input to the mixer 85, and the mixer 85 generates a mixed signal Mx obtained by mixing the waveforms of the measurement signal Tx and the reflection signal Rx. Specifically, the mixer 85 included in the radar transmission/reception circuit 81 functioning as a part of the level determination unit 88 mixes the measurement signal Tx and the reflection signal Rx to generate an IF signal (IF: intermediate frequency) as the mixed signal Mx.

The IF signal (intermediate frequency signal) has a waveform including a high frequency component derived from the frequency of the 60 GHz band of the measurement signal Tx and the reflection signal Rx and a low frequency component corresponding to the frequency difference ΔF between the measurement signal Tx and the reflection signal Rx. The IF signal is input to the low-pass filter 86, and a low-frequency waveform according to the frequency difference ΔF is extracted. The extracted low-frequency waveform is input to the analog-to-digital converter 87. The analog-to-digital converter 87 converts a low-frequency waveform into a digital value and outputs the digital value to the signal processing unit 89.

The signal processing unit 89 that functions as a part of the level determination unit 88 converts the low-frequency waveform output from the analog-to-digital converter 87 into a frequency signal Px by fast Fourier transform processing or the like. The frequency signal Px is a signal indicating the strength of the wave for each frequency, and a frequency corresponding to the maximum peak PS of the frequency signal Px is a frequency difference ΔF between the measurement signal Tx and the reflection signal Rx. The signal processing unit 89 transmits the frequency signal Px to the calculation unit 64 in FIG. 4.

The calculation unit 64 functioning as a part of the level determination unit 88 calculates the values of the distance YA and the level Y based on the frequency signal Px. In calculating the values of the distance YA and the level Y, the calculation unit 64 refers to the information stored in the storage unit 63. For example, the storage unit 63 stores a correspondence relationship between the frequency difference ΔF and the distance YA, a value (container information such as the height of the container 70) for calculating the level Y from the distance YA, and the like.

Further, depending on the measurement environment, a peak other than the maximum peak PS may appear in the frequency signal Px due to an element other than the interface 74 of the object 72 (for example, a device such as a stirrer provided in the container 70). Even if there are a plurality of peaks in the frequency signal Px, the calculation unit 64 can specify only the maximum peak PS derived from the object 72 by appropriately performing calculation. For example, the data of the frequency signal Px obtained in advance in a state where there is no object 72 (state where the container 70 is empty) may be stored in the storage unit 63. The calculation unit 64 can specify the maximum peak PS derived from the object 72 by examining a difference between the frequency signal Px obtained in a state where the object 72 does not exist and the frequency signal Px obtained in a state where the object 72 exists.

After calculating the frequency difference ΔF corresponding to the maximum peak PS of the frequency signal Px, the calculation unit 64 calculates the values of the distance YA and the level Y based on the frequency difference ΔF and the information stored in the storage unit 63. In this manner, the calculation unit 64 functioning as a part of the level determination unit 88 determines the level Y of the object 72 based on the intermediate frequency signal. The calculation unit 64 transmits the calculated value of the level Y to the output unit 66. The output unit 66 changes the display content of the display portion 20 and the lighting state of the indicator lamp 52 according to the value of the level Y. In addition, the value of the level Y is sent to the management device 90 (FIG. 3) through the external output terminal 12D. The output unit 66 may output a binary or multi-valued control signal based on the comparison result between the calculated value of the level Y and the threshold to the management device 90 through the external output terminal 12D. In addition, instead of the value of the level Y itself, a signal indicating that specific control according to the state of the level Y is to be executed may be sent to the management device 90. For example, when the level Y is above a certain threshold or below a certain threshold, a signal indicating that the operation of the pump, valve or the like should be changed may be sent to the management device 90.

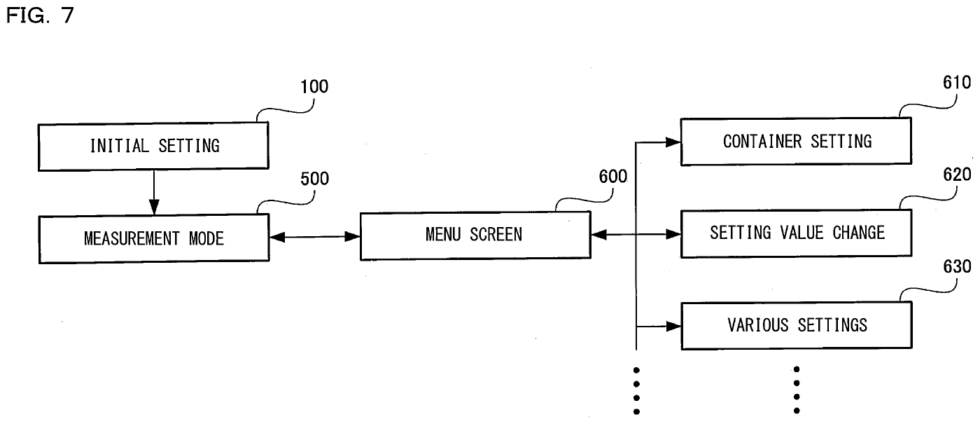

Next, the state transition of the level meter 10 will be described with reference to FIG. 7. First, when the level meter 10 is activated, initial setting 100 is started. As will be described in detail later, in the initial setting 100, miscellaneous setting screens for sequentially setting the container information, the level setting value, and the like are sequentially displayed on the display portion 20. Note that, in the initial setting 100, an operation condition of the level meter 10 such as whether the level meter 10 outputs an analog signal for a measurement value or performs serial communication with an external device may be set. On the other hand, there may be an operation condition that is not displayed in the initial setting 100 and is not set by the user. For example, an operation condition that one of the terminals included in the external output terminal 12D outputs an analog value may be determined in advance regardless of the user's operation. In addition, an operation condition that communication with an external device is automatically performed according to the external device connected to the level meter 10 may be determined in advance. For example, when the level meter 10 is connected to a device (master device) that manages the level meter 10, communication between the level meter 10 and the master device may be automatically performed by IO-Link communication defined in IEC61131-9 (IEC: International Electrotechnical Commission).

When the initial setting 100 is completed, the level meter 10 enters a measurement mode 500. In the measurement mode 500, the level meter 10 measures the level Y of the object 72. In the measurement mode 500, as illustrated in FIG. 1, the relative position of the level setting value with respect to the container 70 is displayed on the display portion 20 together with the bar display 22.

In the measurement mode 500, the display portion 20 can display a menu screen 600. The display screen of the measurement mode 500 for displaying the bar display 22 and the like and the menu screen 600 can mutually transition. For example, every time the user operates the menu key 32 in the measurement mode 500, the display content of the display portion 20 is preferably switched between the display screen of the measurement mode 500 and the menu screen 600.

A plurality of options corresponding to individual setting contents are displayed on the menu screen 600. In response to the user's selection, the display contents of the display portion 20 transition from the menu screen 600 to individual setting screens such as a container setting screen 610, a setting value change screen 620, and a miscellaneous setting screen 630. The menu screen 600 and the individual setting screen can mutually transition. For example, when the left key 38 is operated on an individual setting screen, the display portion 20 preferably returns to the menu screen 600.

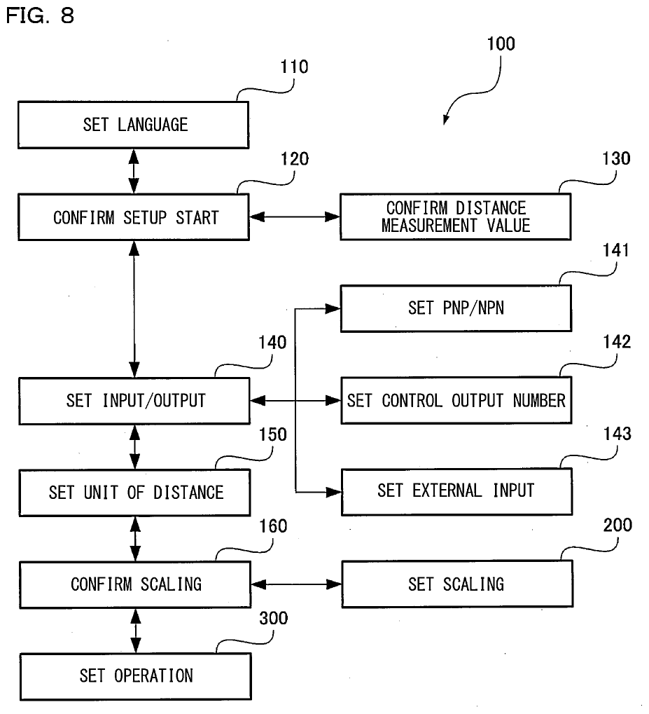

Next, screen transition of the display portion 20 in the initial setting 100 will be described with reference to FIG. 8. In the initial setting 100, a plurality of setting screens for sequentially setting the container information regarding the container 70, a plurality of level setting values regarding the level Y, and the like are displayed while transitioning one by one. On each of the setting screens, the container information, the level setting value of the level Y, and the like are sequentially set by the setting unit 61. Specifically, the setting unit 61 sequentially displays a setting screen for setting the container information, the level setting value of the level Y, and the like in the display portion 20, and sequentially sets the container information, the level setting value, and the like by storing the setting contents selected on the individual setting screen by the user in the storage unit 63. Note that the processing of actually storing the setting contents selected by the user in the initial setting 100 to the storage unit 63 is preferably performed after all the settings in the initial setting 100 are completed (after a setup completion confirmation screen 390 to be described later). That is, the contents set by the user on the individual setting screens included in the initial setting 100 may be temporarily held by the setting unit 61, and the held contents may be collectively stored in the storage unit 63 after completion of the initial setting 100. Details of the display content of each setting screen will be described later.

When the initial setting 100 is started, first, a language setting screen 110 is displayed on the display portion 20. On the language setting screen 110, the user selects a language (English, Japanese, etc.) to be used for display on the display portion 20.

When the language setting is completed, a setup start confirmation screen 120 for confirming to the user whether to start setup of the level meter 10 (initial setting of various setting values) is displayed on the display portion 20. On the setup start confirmation screen 120, the display portion 20 can return to the language setting screen 110 according to the user's operation (for example, the operation of the left key 38). Thereafter, similarly in other setting screens, the display portion 20 can return from the individual setting screen to the previous screen until the initial setting 100 is completed.

In a case where the user selects that the setup is not started yet on the setup start confirmation screen 120, the display portion 20 displays a distance measurement value confirmation screen 130. On the distance measurement value confirmation screen 130, the distance calculated by the level meter 10 from the measurement signal Tx and the reflection signal Rx is displayed on the display portion 20. The distance displayed on the distance measurement value confirmation screen 130 is the distance from the measurement reference surface XS of the level meter 10 to the object reflecting the measurement signal Tx. This distance is a value that can be measured by the level meter 10 even if the level meter 10 is not attached to the container 70 or the container information is not set. By checking the distance displayed on the distance measurement value confirmation screen 130, the user can determine whether the level meter 10 is correctly attached to the container 70 containing the object 72 to be measured. For example, in a case where the displayed distance is out of the range assumed as the distance from the level meter 10 to the object 72, or in a case where the displayed distance is unstable, the level meter 10 may not be correctly attached to the container 70. In a case where the user determines on the distance measurement value confirmation screen 130 that the level meter 10 is correctly attached to the container 70, the user may return to the setup start confirmation screen 120 to start setup.

In a case where the user selects to start setup on the setup start confirmation screen 120, the display portion 20 displays an input/output setting screen 140. A plurality of options are displayed on the input/output setting screen 140. According to the user's selection, the display portion 20 transitions from the input/output setting screen 140 to individual setting screens such as a PNP/NPN setting screen 141, a control output number setting screen 142, and an external input setting screen 143. Note that the user can also skip setting on the PNP/NPN setting screen 141, the control output number setting screen 142, and the external input setting screen 143. Regarding the contents set on the PNP/NPN setting screen 141, the control output number setting screen 142, and the external input setting screen 143, an initial setting value is determined in advance, and in a case where the user skips the setting, the initial setting value is used. Note that an initial setting value may be determined in advance for a setting item set on another setting screen.

On the PNP/NPN setting screen 141, characteristics (PNP transistor or NPN transistor) of the transistors used for the external output and the external input of the level meter 10 are set. The characteristic of the connection portion 12 is determined according to the selection on the PNP/NPN setting screen 141. For example, it is determined which of the plurality of terminals included in the connection portion 12 serves as the external input terminal 12C and the external output terminal 12D. Alternatively, it is determined whether the signal output from the external output terminal 12D becomes a high voltage (high level, e.g. 5 V) or a low voltage (low level, e.g. 0 V) when the condition set by the user is satisfied. On the PNP/NPN setting screen 141, the display portion 20 may display, for example, options of “PNP” and “NPN” to allow the user to select one of the options. For example, in a case where the terminals included in the connection portion 12 include one analog output terminal that outputs an analog value, four digital output terminals that output a digital signal, and one input/output terminal capable of switching between input and output, it is preferable that the output voltage of the digital output terminal be set and input/output of the input/output terminal be switched on the PNP/NPN setting screen 141.

On the control output number setting screen 142, the number of control signals output from the level meter 10 is set. For example, in a case where a plurality of terminals (signal lines) are present as the external output terminal 12D, how many external output terminals 12D are to be used in the current measurement is set. The number of control signals set on the control output number setting screen 142 corresponds to the number of thresholds of the level Y set later. Each of the external output terminals 12D corresponds to a threshold set by the user, and when the measured level Y exceeds the threshold (above or below), a signal is output from the external output terminal 12D corresponding to the threshold. On the control output number setting screen 142, the display portion 20 may display, for example, a plurality of options (for example, options of 0, 1, 2, 3, 4, and 5) indicating the number of control signals to allow the user to select one of the options.

On the external input setting screen 143, whether to enable external input is set. When the external input is enabled on the external input setting screen 143, any of the terminals included in the connection portion 12 functions as the external input terminal 12C. On the external input setting screen 143, the display portion 20 may display, for example, options of “OFF” (disable) and “ON” (enable) to allow the user to select one of the options.

When the setting on the input/output setting screen 140 is completed, the display portion 20 transitions to a distance unit setting screen 150. On the distance unit setting screen 150, a unit of distance for expressing the measurement value by the level meter 10 is set.

When the setting on the distance unit setting screen 150 is completed, the display portion 20 transitions to a scaling confirmation screen 160. On the scaling confirmation screen 160, whether to execute scaling setting 200 is selected. In the scaling setting 200, scaling of the display value is performed. In the scaling of the display value, for example, container information, a level setting value, and the like for converting a measurement value (measured in units of distance) by the level meter 10 into a numerical value for display (for example, a display value in units of capacitance) or into a numerical value to be output to the outside are set. Further, the scaling setting 200 includes a plurality of setting screens.

In a case where the user selects execution of the scaling setting 200 on the scaling confirmation screen 160, the display portion 20 transitions to a setting screen of the scaling setting 200. In a case where the user selects not to execute the scaling setting 200, the display portion 20 transitions to a setting screen of operation setting 300. In the operation setting 300, container information, a level setting value, and the like used by the level meter 10 to measure the level Y are set. The operation setting 300 includes a plurality of setting screens.

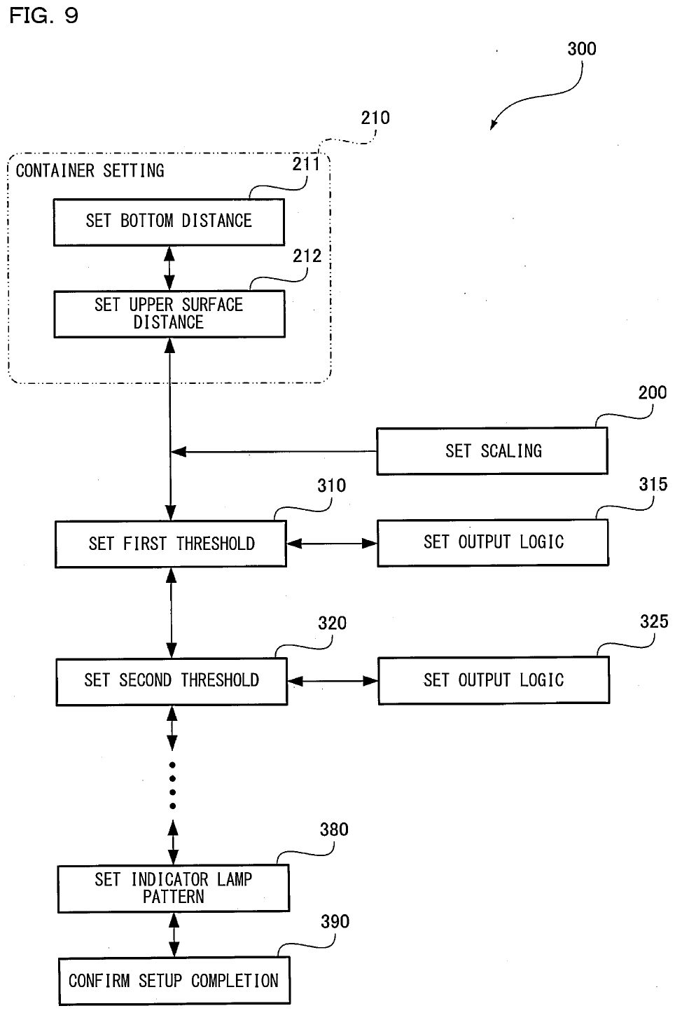

Screen transition of the display portion 20 in the operation setting 300 will be described with reference to FIG. 9. When the operation setting 300 is started, the setting unit 61 first performs container setting 210. In the container setting 210, container information regarding the container 70 is set.

In the container setting 210, the setting unit 61 first displays a bottom distance setting screen 211 in the display portion 20. On the bottom distance setting screen 211, the setting unit 61 causes the user to set the distance (bottom distance Y₀) from the measurement reference surface XS of the level meter 10 to the bottom of the container 70.

Next, the setting unit 61 displays an upper surface distance setting screen 212 in the display portion 20. On the upper surface distance setting screen 212, the setting unit 61 causes the user to set the upper surface distance Y₁ from the measurement reference surface XS of the level meter 10 to the upper surface of the inside of the container 70.

When the container setting 210 is completed, the setting unit 61 sequentially displays setting screens for setting the next level setting value. In FIG. 9, after the container setting 210, the setting unit 61 causes the display portion 20 to display a first threshold setting screen 310.

Further, the scaling setting 200 includes a setting item corresponding to the container setting 210. In a case where the scaling setting 200 is performed, the screen transition of the display portion 20 merges with the operation setting 300 after the scaling setting 200 is completed. Specifically, after the scaling setting 200 is completed, the first threshold setting screen 310 is displayed on the display portion 20.

On the first threshold setting screen 310, the setting unit 61 causes the user to set the first threshold as one of the level setting values related to the level Y. The first threshold is one of thresholds related to the level Y measured by the level meter 10. When level Y exceeds the first threshold (above or below), the operation (for example, the lighting color of the indicator lamp 52, the signal output state of the external output terminal 12D, and the like) of the level meter 10 changes.

In addition, the first threshold setting screen 310 can mutually transition with an output logic setting screen 315 related to the first threshold. On the output logic setting screen 315, how the operation of the level meter 10 changes in a case where the level Y measured by the level meter 10 changes with respect to the threshold (above or below) is set. Specifically, whether the characteristic of the external output terminal 12D corresponding to the first threshold is normally open or normally closed is set. In a case where the normal open is selected and the level Y exceeds the first threshold, the operation of the level meter 10 changes (for example, the signal of the corresponding external output terminal 12D enters the enabled state). In the case that the normal close is selected, the operation of level meter 10 changes in a case where the level Y becomes lower than the first threshold.

When the setting on the first threshold setting screen 310 is completed, the setting unit 61 then causes the display of the display portion 20 to transition to a second threshold setting screen 320. On the second threshold setting screen 320, the setting unit 61 causes the user to set the second threshold similarly to the setting of the first threshold on the first threshold setting screen 310. The second threshold setting screen 320 can mutually transition with an output logic setting screen 325 related to the second threshold.

Such a setting regarding the threshold is repeated by the number of control signals set on the control output number setting screen 142. Here, the setting combining the setting of the numerical value and the setting of the output logic is sequentially performed for each of the thresholds. However, after only the numerical values of all the thresholds are sequentially set, the setting of the output logic of all the thresholds may be sequentially performed. For example, after the first threshold setting screen 310 and the second threshold setting screen 320 are displayed in this order, the output logic setting screen 315 related to the first threshold and the output logic setting screen 325 related to the second threshold may be displayed in this order. Further, in a case where the number of control signals is one, only the first threshold is set. In addition, in a case where the number of control signals is zero, the setting related to the threshold is skipped.

When the setting of all the thresholds and the output logic setting are completed, the display of the display portion 20 transitions to an indicator lamp pattern setting screen 380. On the indicator lamp pattern setting screen 380, how the indicator lamp 52 is turned on is set according to the relative relationship between the measured level Y and the threshold (level setting value). The setting contents on the indicator lamp pattern setting screen 380 include the setting of the lighting color of the indicator lamp 52 corresponding to the level range to which the measured level Y belongs. In addition, how each section of the color gauge 24 is color-coded is also determined according to the lighting color of the indicator lamp 52 set on the indicator lamp pattern setting screen 380.

When the setting on the indicator lamp pattern setting screen 380 is completed, the display in the display portion 20 transitions to the setup completion confirmation screen 390 for confirming to the user whether the setup (initial setting) is completed. When the user determines setup completion on the setup completion confirmation screen 390, the initial setting 100 including the operation setting 300 is completed, and the level meter 10 transitions to the measurement mode 500 in FIG. 7. In a case where the setup is not completed yet, the user can sequentially return the display of the display portion 20 to a screen (indicator lamp pattern setting screen 380, second threshold setting screen 320, and the like) before the setup completion confirmation screen 390 and perform various settings in the initial setting 100 again.

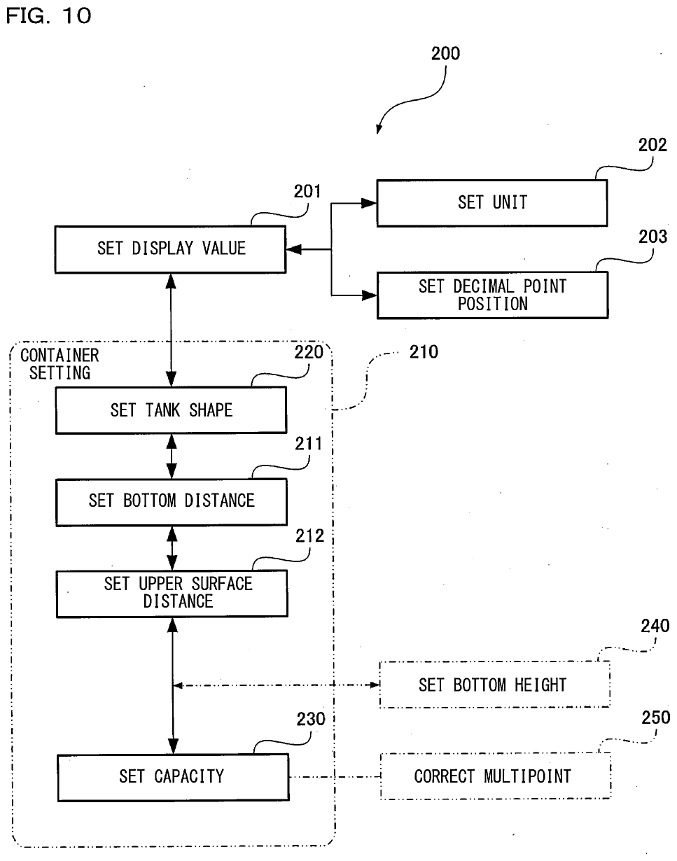

Next, screen transition of the display portion 20 in the scaling setting 200 will be described with reference to FIG. 10. In a case where the user selects to perform the scaling setting 200 on the scaling confirmation screen 160 during the initial setting 100 in FIG. 8, the setting unit 61 first causes the display portion 20 to display a display value setting screen 201 as illustrated in FIG. 10.

The display value setting screen 201 includes options of unit setting and decimal point position setting. In response to the user's selection on the display value setting screen 201, the display in the display portion 20 transitions to a unit setting screen 202 or a decimal point position setting screen 203.

On the unit setting screen 202, the unit in which the measurement value displayed on the auxiliary display portion 26 of the display portion 20 in the measurement mode 500 is displayed is set. For example, in addition to units of distance such as m and mm, options of the units of volume such as L (liter) and cubic meter, the units of weight such as g (gram), and the units of ratio such as percentage (%) with respect to the full capacity value are displayed on the display portion 20. Here, in a case where a unit other than the units of distance is selected, the measurement value displayed on the auxiliary display portion 26 is a value obtained by converting the level Y measured by the level meter 10 into the amount of the object 72 in the container 70. Further, in a case where a unit of weight is set, it is preferable to set the specific gravity of the object 72. For example, in a case where a unit of weight is set, the display portion 20 may transition to a screen for setting the specific gravity of the object 72.

On the decimal point position setting screen 203, the number of digits of the integer part and the number of digits of the fractional part are set for the measurement value displayed on the auxiliary display portion 26 of the display portion 20 in the measurement mode 500. For example, a plurality of display examples having different decimal point display positions may be displayed on the display portion 20, and a display example corresponding to a decimal point display position desired by the user may be selected.

When the setting on the display value setting screen 201 is completed, the setting unit 61 then performs the container setting 210 in the scaling setting 200. The container setting 210 in the scaling setting 200 includes a tank shape setting screen 220, a capacity setting screen 230, and the like in addition to the bottom distance setting screen 211 and the upper surface distance setting screen 212 similar to the container setting 210 in the operation setting 300 in FIG. 9.

In the container setting 210 in the scaling setting 200, the setting unit 61 first displays the tank shape setting screen 220 in the display portion 20. On the tank shape setting screen 220, the shape of the container 70 to which the level meter 10 is attached is set as one of the container information. As a specific example, a shape corresponding to the container 70 may be selected from options of a straight tank (vertical cylindrical tank, prismatic tank, etc.), a horizontal cylindrical tank, a spherical tank, a pyramid tank, a conical bottom tank, and the like. In addition, in order to correspond to the container 70 having a complicated shape, it is preferable to be able to set multipoint correction in which the correspondence relationship between the level Y and the volume of the object 72 is determined by a plurality of correction points.

When the setting on the tank shape setting screen 220 is completed, the setting unit 61 then sequentially displays the bottom distance setting screen 211 and the upper surface distance setting screen 212 in the display portion 20, and sequentially sets the bottom distance Y₀ and the upper surface distance Y₁ of the container 70.

When the setting on the upper surface distance setting screen 212 is completed, the setting unit 61 then displays the capacity setting screen 230 in the display portion 20. On the capacity setting screen 230, as one of the container information, a full capacity value of the container 70 is set as a volume value. Specifically, the volume of the object 72 when the level Y of the object 72 reaches the position of the upper surface inside the container 70 is preferably set as the full capacity value. Further, the value of the level Y when the object 72 reaches the full capacity value corresponds to the value of the height of the container 70. The value of the height of the container 70 corresponds to a difference between the bottom distance Y₀ of the container 70 set on the bottom distance setting screen 211 and the upper surface distance Y₁ set on the upper surface distance setting screen 212, and a value of Y₀−Y₁.

When the setting on the capacity setting screen 230 is completed, the scaling setting 200 is completed, and the screen transition of the display portion 20 merges with the operation setting 300 in FIG. 9. Further, depending on the contents set on the tank shape setting screen 220, a setting item in the container setting 210 may be added or changed.

For example, in a case where the container 70 has a shape in which the container 70 includes an inclined shape, such as a conical bottom tank or a pyramid tank, and the value of the level Y and the volume of the object 72 are not in a simple proportional relationship, a bottom height setting screen 240 is displayed on the display portion 20 next to the upper surface distance setting screen 212 and before the capacity setting screen 230. On the bottom height setting screen 240, the height from the bottom of the container 70 to the upper end of the inclined shape (the position of the straight shape) is set.

In addition, in a case where multipoint correction is selected on the tank shape setting screen 220, a multipoint correction screen 250 is displayed on the display portion 20 instead of the capacity setting screen 230. In the multipoint correction screen 250, a plurality of correction points are set using a combination of the value of the level Y of the object 72 and the value of the volume of the object 72 corresponding to the value of the level Y as one correction point.

As described above, the initial setting 100 of the level meter 10 is performed. In the initial setting 100, the setting unit 61 sequentially displays a screen for setting the container information regarding the container 70, a plurality of level setting values regarding the level Y, and the like in the display portion 20, so that the container information, the level setting values, and the like are sequentially set. The display screen of the display portion 20 transitions one by one according to the user's operation. Then, in each display screen, among a plurality of setting items including the container information and the level design value, a setting item corresponding to the display screen being displayed is set. Thus, the setting of the plurality of setting items can be completed by the level meter 10 alone. Therefore, when performing the setting for level measurement, the user does not need to connect a wire for wired communication or perform setting for wireless communication to cause the level meter 10 to communicate with an external device, for example, and the user's work is simplified.

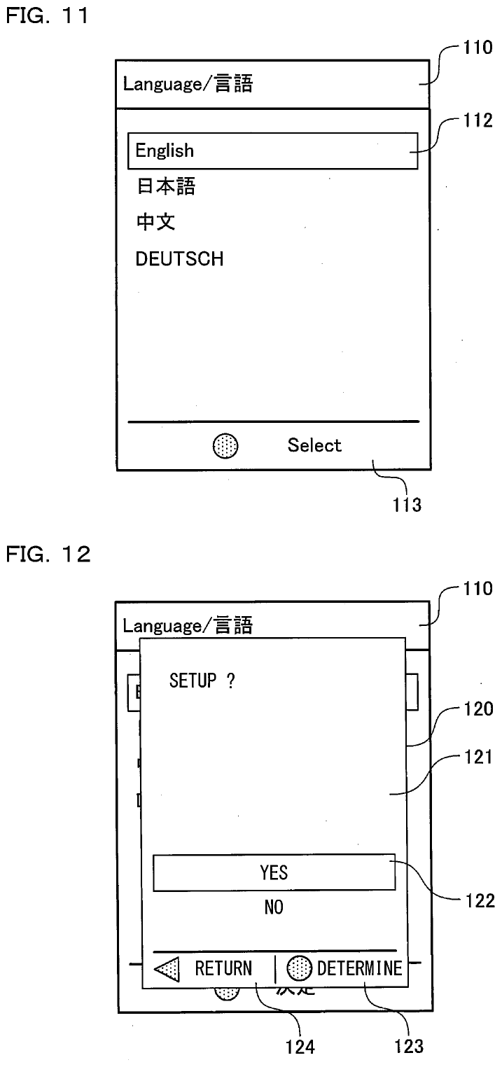

Hereinafter, individual screens displayed on the display portion 20 in the initial setting 100 will be described in more detail with reference to the drawings. FIG. 11 illustrates a language setting screen 110 displayed on the display portion 20 at the time of starting the initial setting 100.

On the language setting screen 110, options of a plurality of languages (in FIG. 11, English, Japanese, Chinese, and DEUTCH) are displayed. In a case where there are a plurality of options, a cursor 112 is displayed, and the user can move the cursor 112 by operating the direction keys 33. For example, when the up key 36 is operated, the cursor 112 moves to an upper option, and when the down key 35 is operated, the cursor 112 moves to a lower option.

A determination key guide display 113 is displayed at a lower part of the language setting screen 110. The determination key guide display 113 includes an icon imitating a key (the center key 39 in this case) used to decide the option and a character string indicating that the option can be decided by operating the key indicated by the icon. Note that the character string displayed here changes depending on the language of the option to which the cursor 112 is placed. The user can determine the display language by operating the center key 39 with the cursor 112 placed on the desired display language.

When the display language is determined, the setup start confirmation screen 120 illustrated in FIG. 12 is displayed on the display portion 20. In FIG. 12, the setup start confirmation screen 120 is displayed to be superimposed on (overlapped with) the language setting screen 110.

The setup start confirmation screen 120 includes a character string display area 121 that displays a character string (“Setup?”) for confirming whether to start setup (initial setting), an option (“Yes”) to immediately start setup, and an option (“No”) not to start setup yet. In addition, a cursor 122 is displayed to be placed on one of the options.

A determination key guide display 123 and a return key guide display 124 are displayed at the lower part of the setup start confirmation screen 120. Like the determination key guide display 113 of the language setting screen 110, the determination key guide display 123 includes an icon of the center key 39 and a character string “Decision”. The return key guide display 124 includes an icon imitating a key (here, the left key 38) for returning the display content to the previous screen (here, the language setting screen 110), and a character string indicating that the display content can be returned to the previous screen by operating the key indicated by the icon. The display corresponding to the cursor 122, the determination key guide display 123, and the return key guide display 124 is also performed on the other screens, but the description thereof will be omitted below.

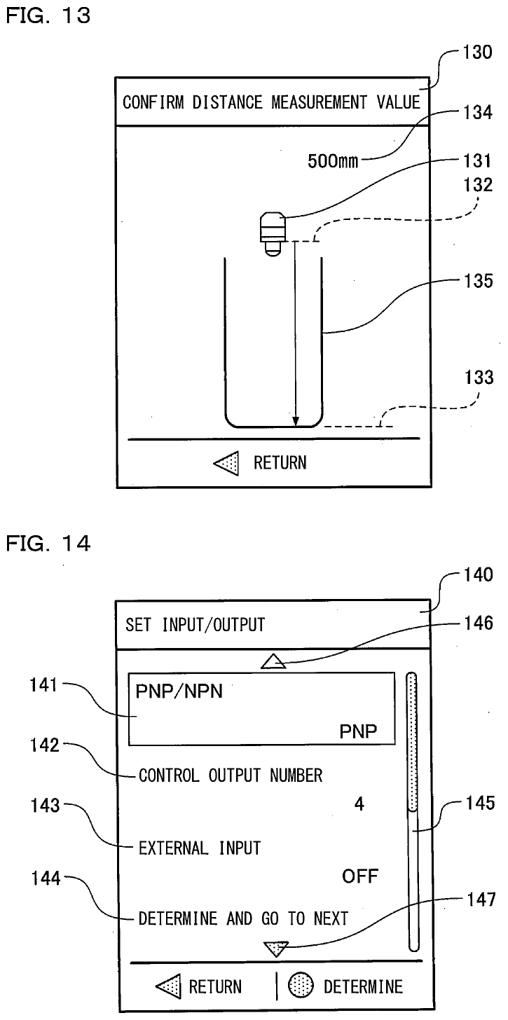

When “No” is selected on the setup start confirmation screen 120, the distance measurement value confirmation screen 130 illustrated in FIG. 13 is displayed on the display portion 20. The distance measurement value confirmation screen 130 includes a level meter icon 131, a measurement reference surface line 132, a container bottom line 133, a distance measurement value display 134, and a container icon 135.

The level meter icon 131 is an icon representing the level meter 10, and imitates the level meter 10. The level meter icon 131 is displayed above the container icon 135. The measurement reference surface line 132 is a line indicating the measurement reference surface XS of the level meter 10, and horizontally extends from a position corresponding to the measurement reference surface XS in the level meter icon 131. The container icon 135 is an icon representing the container 70, and a shape imitating a straight tank is displayed here. The container bottom line 133 is a line indicating the bottom of the container 70, and horizontally extends from a position corresponding to the bottom of the container icon 135. The distance measurement value display 134 indicates a distance value measured by the level meter 10. In the distance measurement value display 134, a distance (500 mm in this case) from measurement reference surface XS of the level meter 10 to the object reflecting measurement signal Tx is displayed as a numerical value.

Then, on the distance measurement value confirmation screen 130, an arrow extends from the measurement reference surface line 132 toward the bottom of the container icon 135. This indicates that when the level meter 10 is attached to an empty container 70 (not including the object 72), the distance from the measurement reference surface XS to the bottom of the container 70 is measured by the level meter 10 and displayed on the distance measurement value display 134. In a case where the user determines on the distance measurement value confirmation screen 130 that the level meter 10 is correctly attached to the container 70, the user may return to the setup start confirmation screen 120 to start setup.

When “Yes” is selected on the setup start confirmation screen 120 of FIG. 12, the input/output setting screen 140 illustrated in FIG. 14 is displayed on the display portion 20. The input/output setting screen 140 includes options of the PNP/NPN setting screen 141, options of the control output number setting screen 142, options of the external input setting screen 143, and an option 144 for proceeding to the next setting. Further, a character string (“PNP”, “4”, “OFF”, and the like) indicating the setting contents set on the PNP/NPN setting screen 141, the control output number setting screen 142, and the external input setting screen 143 is also displayed in each option. In addition, the input/output setting screen 140 also includes a scroll bar 145, an up key display 146, and a down key display 147.

The scroll bar 145 indicates a relative position of the position of the option currently cursor-joined in the entire options on the screen on which the plurality of options are displayed side by side. The up key display 146 is an icon imitating the up key 36, and in a case where this icon has a dark color, it indicates that the cursor can be moved upward by operating the up key 36. On the other hand, as illustrated in FIG. 14, in a case where the up key display 146 is in a light color (white in FIG. 14), it indicates that the cursor is aligned with the option at the upper end, and the cursor cannot be moved upward any more. The down key display 147 is an icon imitating the down key 35, and in a case where this icon has a dark color (dot pattern in FIG. 14) as illustrated in FIG. 14, it indicates that the cursor can be moved downward by operating the down key 35. On the other hand, in a case where the down key display 147 is in a light color, it indicates that the cursor is aligned with the option at the lower end, and the cursor cannot be moved downward any more. Hereinafter, description of the scroll bar 145, the up key display 146, and the down key display 147 on other screens will be omitted.

When the center key 39 is operated in a state where the cursor is placed on any of the options on the PNP/NPN setting screen 141, the options on the control output number setting screen 142, and the options on the external input setting screen 143, the display of the display portion 20 transitions to the PNP/NPN setting screen 141, the control output number setting screen 142, and the external input setting screen 143 according to the options. Although details of the PNP/NPN setting screen 141, the control output number setting screen 142, and the external input setting screen 143 are not illustrated, as described above, options of “PNP” and “NPN”, options of 0, 1, 2, 3, 4, and 5, options of “OFF” and “ON”, and the like are displayed on each setting screen.

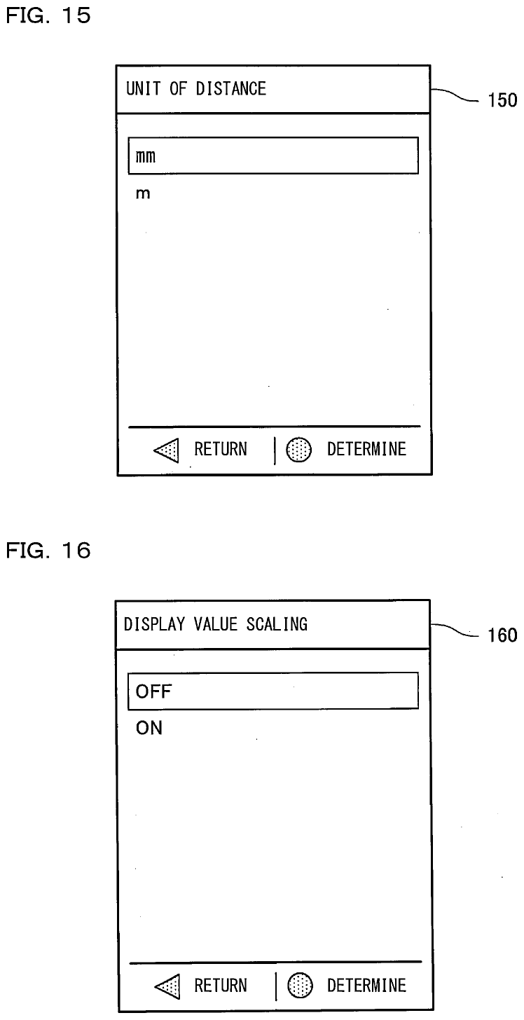

When the center key 39 is operated in a state where the cursor is placed on the option 144 (character string “determine and next”) for proceeding to the next setting on the input/output setting screen 140, the display in the display portion 20 transitions to the distance unit setting screen 150 illustrated in FIG. 15. On the distance unit setting screen 150, a unit of distance for expressing the measurement value by the level meter 10 is set. For example, as illustrated in FIG. 15, an option of “mm” (millimeter) or “m” (meter) is displayed on the distance unit setting screen 150.

When a unit of distance is set on the distance unit setting screen 150, the display in the display portion 20 transitions to the scaling confirmation screen 160 illustrated in FIG. 16. On the scaling confirmation screen 160, whether to execute scaling setting 200 is selected. For example, as illustrated in FIG. 16, an option of “OFF” or “ON” is displayed on the scaling confirmation screen 160. Here, when “ON” is selected, the scaling setting 200 is performed, and when “OFF” is selected, the operation setting 300 is performed.

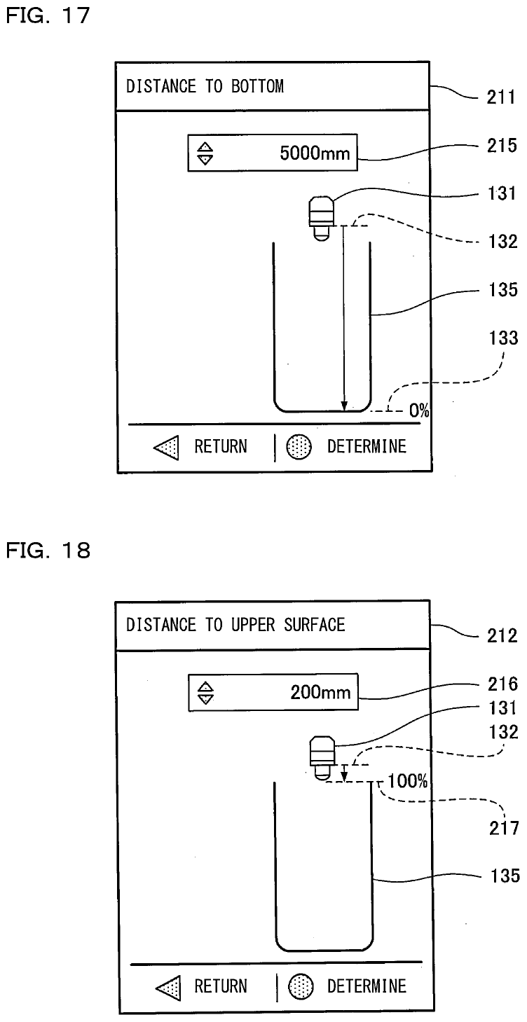

In a case where “OFF” is selected on the scaling confirmation screen 160 and the operation setting 300 is performed, the bottom distance setting screen 211 illustrated in FIG. 17 is first displayed on the display portion 20. The bottom distance setting screen 211 includes a level meter icon 131, a measurement reference surface line 132, a container icon 135, and a bottom distance setting field 215. In addition, although the container bottom line 133 is also illustrated in FIG. 17, the container bottom line 133 may not be displayed on the bottom distance setting screen 211.

On the bottom distance setting screen 211, a distance (bottom distance Y₀) from the measurement reference surface XS of the level meter 10 to the bottom of the container 70 is set by the setting unit 61. An arrow extending from the measurement reference surface line 132 to the bottom of the container icon 135 (the position of the container bottom line 133) is displayed on the bottom distance setting screen 211. This arrow indicates that the numerical value set on the bottom distance setting screen 211 is the distance from the measurement reference surface XS to the bottom of the container 70. In addition, in FIG. 17, in a case where the stored amount of the object 72 in the container 70 is 0% (empty state) with respect to the full amount (100%), the letter “0%” is displayed beside the container bottom line 133 to indicate that the measurement value of the distance by the level meter 10 becomes the bottom distance Y₀. In the bottom distance setting field 215, candidates for the distance to the bottom are displayed as numerical values. As described above, when the container information is set by the setting unit 61, the level meter icon 131 indicating the level meter 10 and the container icon 135 indicating the container 70 are displayed on the display portion 20, so that the user can easily visually grasp the relationship between the set value and the level meter 10 and the container 70. Here, a unit of distance set on the distance unit setting screen 150 is used as the distance measurement unit (mm in this case) displayed in the bottom distance setting field 215. Similarly, when a unit of distance is displayed, the unit of distance set on the distance unit setting screen 150 is used.

When the down key 35 and the up key 36 are operated by the user on the bottom distance setting screen 211, the numerical values displayed in the bottom distance setting field 215 decrease and increase. Then, when the determination key (center key 39) is operated by the user, a numerical value (5000 mm in this case) displayed in the bottom distance setting field 215 is input to the level meter 10. The setting unit 61 sets the input numerical value as a bottom distance Y₀ which is one of the container information. The set numerical value is stored in the storage unit 63 when the initial setting 100 is completed. The user may input a design value of a tank used as, for example, the container 70 as the bottom distance Y₀ of the container 70. Further, a numerical value different from the design value may be input according to various measurement conditions such as a measurement target and an installation state of the level meter 10.

When the bottom distance Y₀ of the container 70 is set on the bottom distance setting screen 211, the display of the display portion 20 transitions to the upper surface distance setting screen 212 illustrated in FIG. 18. The upper surface distance setting screen 212 includes a level meter icon 131, a measurement reference surface line 132, a container icon 135, and an upper surface distance setting field 216. In FIG. 18, a container upper surface line 217 indicating the upper surface inside the container 70 is illustrated as a line horizontally extending from a position corresponding to the inner upper surface of the container icon 135, but the container upper surface line 217 may not be displayed on the upper surface distance setting screen 212.

On the upper surface distance setting screen 212, a distance (upper surface distance Y₁) from the measurement reference surface XS of the level meter 10 to the upper surface inside the container 70 is set. An arrow extending from the measurement reference surface line 132 to the position of the upper surface of the container icon 135 is displayed on the upper surface distance setting screen 212. This arrow indicates that the numerical value set on the upper surface distance setting screen 212 is the distance from the measurement reference surface XS to the upper surface inside the container 70. In addition, in FIG. 18, in a case where the stored amount of the object 72 in the container 70 is the full amount (100%), the letter “100%” is displayed beside the container upper surface line 217 to indicate that the measurement value of the distance by the level meter 10 becomes the upper surface distance Y₁. Further, depending on the shape of the container 70, the position of the upper surface inside the container 70 may be different from the position of the full line in which the object 72 is handled to be full. In this case, the distance from the measurement reference surface XS to the full line may be set as the upper surface distance Y₁. In the upper surface distance setting field 216, candidates for the upper surface distance Y₁ are displayed as numerical values.

When the down key 35 and the up key 36 are operated by the user on the upper surface distance setting screen 212, the numerical values displayed in the upper surface distance setting field 216 decrease and increase. Then, when the determination key (center key 39) is operated by the user, a numerical value (200 mm in this case) displayed in the upper surface distance setting field 216 is input to the level meter 10. The setting unit 61 sets the input numerical value as an upper surface distance Y₁ which is one of the container information. The set numerical value is stored in the storage unit 63 when the initial setting 100 is completed. The user may input the thickness of the top plate of the tank used as, for example, the container 70 as the upper surface distance Y₁. Further, a numerical value different from the design value may be input according to various measurement conditions such as a measurement target and an installation state of the level meter 10. For example, in a case where the level meter 10 is installed further upward away from the top plate of the tank, a numerical value larger than the thickness of the top plate of the tank is input as the upper surface distance Y₁.

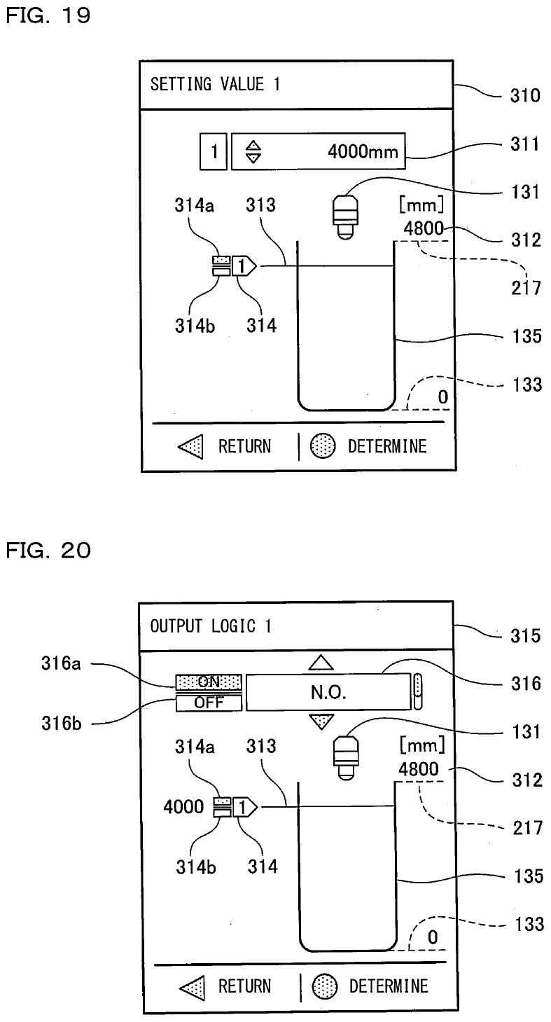

When the upper surface distance Y₁ is set on the upper surface distance setting screen 212, the display of the display portion 20 transitions to the first threshold setting screen 310 illustrated in FIG. 19. The first threshold setting screen 310 includes a level meter icon 131, a container bottom line 133, a container icon 135, a container upper surface line 217, a first threshold setting field 311, a height display 312, a first threshold line 313, a first threshold identifier 314, a normally open icon 314a, and a normally closed icon 314b.

The height display 312 indicates the height of the container 70 (the distance from the bottom of the container 70 to the upper surface inside the container 70) by a numerical value. As the height display 312, a difference between the bottom distance Y₀ set on the bottom distance setting screen 211 and the upper surface distance Y₁ set on the upper surface distance setting screen 212, and a value of Y₀−Y₁ (here, 4800) are displayed together with a unit of measurement (mm). On the other hand, above the container bottom line 133, a number of “0” is displayed to indicate that the reference of the level Y is the bottom of the container 70, that is, the level Y at the bottom of the container 70 is treated as 0.

On the first threshold setting screen 310, the first threshold is set as one of the plurality of level setting values related to the level Y. Since the first threshold is one of the level setting values, “setting value 1” is displayed as the screen name in the upper part of the first threshold setting screen 310 in FIG. 19. The first threshold is set as a distance from the bottom of the container 70. In the first threshold setting field 311, candidates of the first threshold are displayed as numerical values. The first threshold line 313 is displayed as a line extending horizontally with respect to the container icon 135. The first threshold line 313 is displayed at a height corresponding to the first threshold displayed in the first threshold setting field 311.

The height of the first threshold line 313 indicates the relative position of the first threshold with respect to the container 70. The relative position of the first threshold is determined based on the container information on the container 70. Specifically, the first threshold line 313 is arranged at a higher position with respect to the container icon 135 as the ratio of the first threshold to the height of the container 70 (one of the container information) is higher. When setting the first threshold (level setting value), the relative position of the first threshold with respect to the container 70 is displayed together with the level meter icon 131 and the container icon 135, so that the user can perform setting while visually grasping the relative position of the level setting value related to the level Y with respect to the container 70.

The first threshold identifier 314 is displayed side by side with the first threshold line 313. The first threshold identifier 314 indicates a level setting value identifier allocated to the first threshold. The level setting value identifier is an identifier individually allocated to a plurality of level setting values. In FIG. 19, the number “1” is displayed as the level setting value identifier allocated to the first threshold. The level setting value identifier is not limited to a number, and it is sufficient that the level setting value can be individually identified. For example, an alphabet, a symbol, or the like may be used as the level setting value identifier. Further, in FIG. 19, the same identifier as the first threshold identifier 314 is also displayed next to the first threshold setting field 311.

The normally open icon 314a and the normally closed icon 314b are displayed side by side with the first threshold identifier 314. The normally open icon 314a is arranged above the normally closed icon 314b. The normally open icon 314a and the normally closed icon 314b indicate characteristics of the first threshold (output logic of the external output terminal 12D corresponding to the first threshold).

The characteristic of the first threshold is a setting condition that in which case the operation of level meter 10 is changed (for example, the signal of external output terminal 12D is changed) between a case where the level Y exceeds the first threshold and a case where the level Y falls below the first threshold. In a case where the characteristic of the first threshold is normally opened, the operation of the level meter 10 changes when the level Y exceeds the first threshold (for example, any output of the external output terminal 12D is turned on). The normally open icon 314a is arranged above the first threshold line 313 to indicate that a change occurs in a case where the level Y exceeds the first threshold. In a case where the characteristic of the first threshold is normally closed, the operation of the level meter 10 changes when the level Y falls below the first threshold. The normally closed icon 314b is disposed below the first threshold line 313 to indicate that a change occurs in a case where the level Y falls below the first threshold.

Of the normally open icon 314a and the normally closed icon 314b, the icon that is enabled is displayed in a darker color (dot pattern in FIG. 19), and the icon that is disabled is displayed in a lighter color (white in FIG. 19). In the initial state, either the normally open icon 314a or the normally closed icon 314b (here, the normally open icon 314a) is enabled.

When the down key 35 and the up key 36 are operated by the user on the first threshold setting screen 310, the numerical value of the first threshold displayed in the first threshold setting field 311 decreases and increases. As the numerical value of the first threshold changes, the height of the first threshold line 313 also changes. As the height of the first threshold line 313 changes, the heights of the first threshold identifier 314, the normally open icon 314a, and the normally closed icon 314b also change. When the determination key (center key 39) is operated by the user, a numerical value (4000 mm in this case) displayed in the first threshold setting field 311 is input to the level meter 10. The setting unit 61 sets the input numerical value as a first threshold that is one of the level setting values. The set numerical value is stored in the storage unit 63 when the initial setting 100 is completed. Further, the plurality of thresholds (level setting values) including the first threshold are set as values indicating that “If the level Y exceeds or falls below this value, the amount of the object 72 needs to be adjusted” for the object 72 in the container 70, for example.

When the first threshold is set, the display of the display portion 20 transitions to the output logic setting screen 315 illustrated in FIG. 20. The display contents of the output logic setting screen 315 take over the display contents of the first threshold setting screen 310. On the output logic setting screen 315, an output logic setting field 316 is displayed instead of the first threshold setting field 311. In addition, on the output logic setting screen 315, the numerical value of the first threshold set on the first threshold setting screen 310 (here, “4000”) is displayed side by side with the first threshold identifier 314 (next to the normally open icon 314a and the normally closed icon 314b in FIG. 20).

On the output logic setting screen 315, an ON icon 316a and an OFF icon 316b are displayed side by side with the output logic setting field 316. The ON icon 316a and the OFF icon 316b visually indicate the characteristic (output logic) of the first threshold in an easy-to-understand manner. In a case where the characteristic of the first threshold is normally opened, the ON icon 316a is arranged above the OFF icon 316b to indicate that the operation of the level meter 10 changes (enters the ON state) when the level Y exceeds the first threshold. On the other hand, although not illustrated in FIG. 20, in a case where the characteristic of the first threshold is the normal close, the ON icon 316a is arranged below the OFF icon 316b to indicate that the operation of the level meter 10 changes (enters the ON state) when the level Y falls below the first threshold. The ON icon 316a is displayed in a dark color (dot pattern in FIG. 20) indicating the enabled state, and the OFF icon 316b is displayed in a light color (white in FIG. 20) indicating the disabled state.

On the output logic setting screen 315, output logic related to the first threshold is set. Specifically, whether the characteristic of the external output terminal 12D corresponding to the first threshold is normally open or normally closed is set. In the output logic setting field 316, a character string of “N.O.” indicating that the characteristic is Normal Open or a character string of “N.C.” indicating that the characteristic is Normal Close is displayed. When the down key 35 and the up key 36 are operated by the user, the character string displayed in the output logic setting field 316 is switched between “N.O.” and “N.C.”. As the character string in the output logic setting field 316 is switched, the positions of the ON icon 316a and the OFF icon 316b are switched. In addition, with the switching of the character string in the output logic setting field 316, the normally open icon 314a and the normally closed icon 314b are switched between the enabled state and the disabled state.

As illustrated in FIG. 20, in a case where the display of the output logic setting field 316 is “N.O.”, the icons in the enabled state (the normally open icon 314a and the ON icon 316a in the enabled state) are arranged above the icons in the disabled state (the normally closed icon 314b and the OFF icon 316b in the disabled state). On the other hand, in a case where the display of the output logic setting field 316 is “N.C.”, the icons in the enabled state (the normally closed icon 314b and the ON icon 316a in the enabled state) are arranged below the icons in the disabled state (the normally open icon 314a and the OFF icon 316b in the disabled state).

When the determination key (center key 39) is operated by the user on the output logic setting screen 315, the characteristic (normally open or normally closed) corresponding to the character string displayed in the output logic setting field 316 is set as the output logic related to the first threshold. The setting unit 61 also sets the selection result of the option related to such a threshold as one of the level setting values related to the level Y.

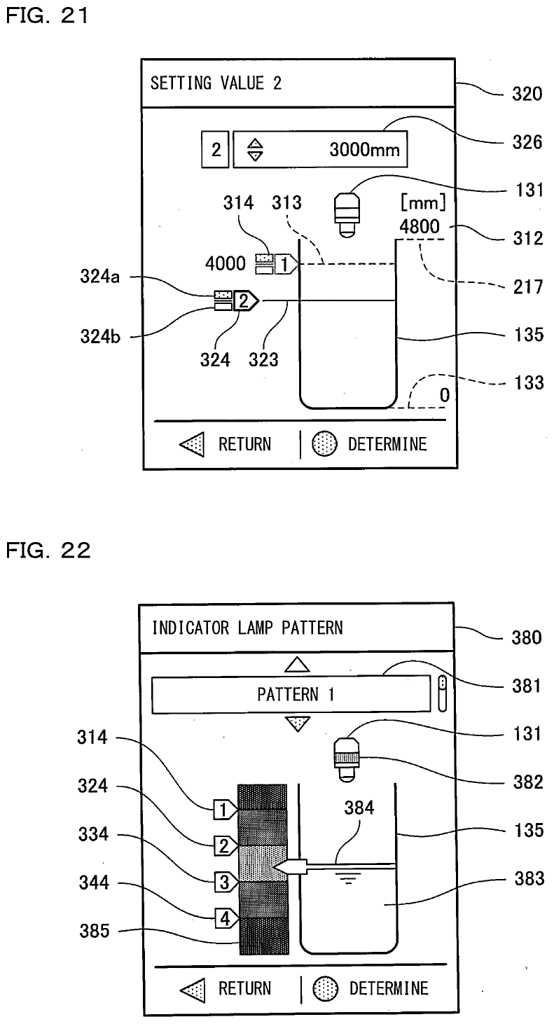

When the output logic related to the first threshold is set, the display of the display portion 20 transitions to the second threshold setting screen 320 illustrated in FIG. 21. Similarly to the various display components displayed for setting the first threshold on the first threshold setting screen 310, a second threshold line 323, a second threshold identifier 324, a normally open icon 324a related to the second threshold, a normally closed icon 324b related to the second threshold, and a second threshold setting field 326 are displayed on the second threshold setting screen 320.

In addition, on the second threshold setting screen 320, the first threshold line 313 and the first threshold identifier 314 related to the already set first threshold, the numerical value (4000 in this case) of the first threshold, and the like are also displayed. However, in order to distinguish from the currently set second threshold, the display component related to the first threshold is displayed so as not to be conspicuous (for example, grayed out). When setting a new level setting value (second threshold), the relative position of the set level setting value (first threshold) with respect to the container 70 is displayed, so that the user can set the new level setting value while being conscious of the relative relationship with the set level setting value.

When the second threshold is set on the second threshold setting screen 320, the display of the display portion 20 transitions to the output logic setting screen related to the second threshold. Although the output logic setting screen related to the second threshold is not illustrated, the display content of the output logic setting screen related to the second threshold takes over the display content on the second threshold setting screen 320. The setting of the output logic related to the second threshold is performed similarly to the output logic setting screen 315 (FIG. 20) of the first threshold.

The setting of the numerical value of the threshold and the output logic setting of the threshold are repeated by the same number as the number of control outputs (the number of control signals) set on the control output number setting screen 142 transitioning from the input/output setting screen 140 of FIG. 14. When the new threshold is set, not only the relative position of the new threshold with respect to the container 70 is displayed, but also the relative positions of all the previously set thresholds with respect to the container 70 are displayed. Note that, here, the setting combining the setting of the numerical value of the threshold and the setting of the output logic is sequentially performed for each of the thresholds. However, after only the numerical values of all the thresholds are sequentially set, the setting of the output logic of all the thresholds may be sequentially performed. For example, after the first threshold setting screen 310 and the second threshold setting screen 320 are displayed in this order, the output logic setting screen 315 related to the first threshold and the output logic setting screen 315 related to the second threshold may be displayed in this order.

When the setting of the numerical values and the output logic of all the thresholds is completed, the display of the display portion 20 transitions to an indicator lamp pattern setting screen 380 illustrated in FIG. 22. Here, it is assumed that four thresholds are set. The indicator lamp pattern setting screen 380 includes a level meter icon 131, a container icon 135, a virtual color gauge 385, and an indicator lamp pattern setting field 381. The level meter icon 131 displayed on the indicator lamp pattern setting screen 380 includes an indicator lamp icon 382 that virtually indicates the change in the lighting state of the indicator lamp 52 with the increase or decrease of the level Y. In addition, in the container icon 135 displayed on the indicator lamp pattern setting screen 380, a virtual bar display 383 virtually indicating expansion and contraction of the bar display 22 (of the measurement mode 500) accompanying the increase and decrease of the level Y is displayed.

It is preferable that the virtual bar display 383 visually indicates a state in which a larger amount of the objects 72 (for example, liquid) are stored in the container 70 as the virtual bar display 383 extends longer. For example, it is preferable to perform gradation display in which the virtual bar display 383 is colored in blue and the concentration of blue changes in stages in the container icon 135. For example, the virtual bar display 383 is preferably dark blue on the lower end side (position close to the bottom of the container icon 135), light blue on the upper end side (position close to the upper surface of the container icon 135), and the concentration changes stepwise (or continuously) from dark blue to light blue.

A virtual bar arrow 384 is displayed at the upper end of the virtual bar display 383. The virtual bar arrow 384 extends in the horizontal direction toward the virtual color gauge 385. The virtual color gauge 385 is displayed side by side with the container icon 135. The virtual color gauge 385 is a gauge having the same length as the entire length of the container icon 135 (distance from the bottom position to the top position). The virtual color gauge 385 is color-coded into a plurality of sections. A boundary between the sections of the virtual color gauge 385 is a relative position of each threshold with respect to the entire length of the container icon 135. In FIG. 22, four thresholds are set, and the virtual color gauge 385 is divided into five sections.

The level setting value identifier assigned to the corresponding threshold is displayed next to the boundary between the sections of the virtual color gauge 385. In FIG. 22, a first threshold identifier 314, a second threshold identifier 324, a third threshold identifier 334, and a fourth threshold identifier 344 are displayed in order from the top. In addition, the color of the indicator lamp icon 382 is the same as the color of the section of the virtual color gauge 385 indicated by the virtual bar arrow 384. In FIG. 22, the virtual bar arrow 384 indicates the third section from the top, and the indicator lamp icon 382 has the same color as the third section from the top.

When the down key 35 and the up key 36 are operated by the user on the indicator lamp pattern setting screen 380, the pattern name (“pattern 1” in FIG. 22) displayed in the indicator lamp pattern setting field 381 is switched. A plurality of pattern names are prepared, and the color-coding pattern for each section of the virtual color gauge 385 changes according to the pattern name. In “pattern 1”, the five sections of the virtual color gauge 385 are color-coded with three colors. Specifically, the top and bottom sections are the first color (for example, red), the second and fourth sections from the top are the second color (for example, yellow), and the third (center) from the top is the third color (for example, green). The color-coding pattern of the virtual color gauge 385 corresponds to a change pattern of the lighting state of the indicator lamp 52 according to the increase or decrease of the level Y.

Then, on the indicator lamp pattern setting screen 380, an animation image showing a change in the operation of the level meter 10 with the increase or decrease of the level Y is displayed. This animation image includes a virtual bar display 383 and an indicator lamp icon 382. Specifically, while the indicator lamp pattern setting screen 380 is displayed, the virtual bar display 383 repeats expansion and contraction. For example, the virtual bar display 383 extends from the bottom to the upper surface of the container icon 135 and starts to contract when reaching the upper surface. Then, when the virtual bar display 383 contracts to the bottom of the container icon 135, the virtual bar display 383 starts to expand again. Note that the expansion/contraction of the virtual bar display 383 does not indicate a change in the actual level Y, but indicates a change in a virtual measurement value (dummy value).

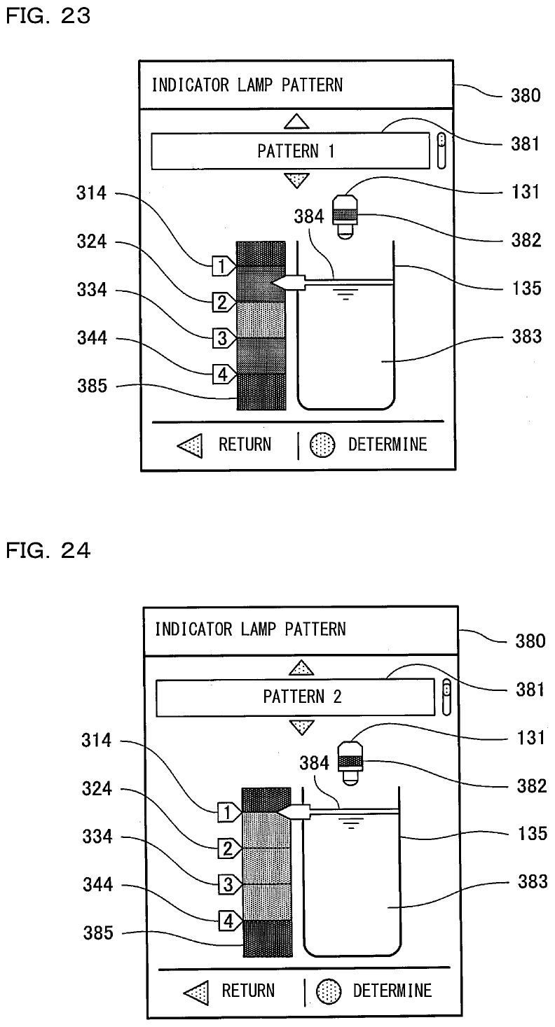

As the virtual bar display 383 expands and contracts, the state (color) of the indicator lamp icon 382 also changes. FIG. 23 illustrates changes of the indicator lamp pattern setting screen 380 using animation. In FIG. 23, the virtual bar display 383 extends more than the state of FIG. 22, and the virtual bar arrow 384 indicates the second section from the top of the virtual color gauge 385. Then, the color of the indicator lamp icon 382 changes to the color of the second section from the top. As described above, on the indicator lamp pattern setting screen 380, the animation image including the virtual bar display 383 that repeats expansion and contraction and the indicator lamp icon 382 whose color changes with expansion and contraction of the virtual bar display 383 is displayed. By repeating the expansion and contraction of the virtual bar display 383, the expansion and contraction of the bar display 22 accompanying the increase and decrease of the level Y in the measurement mode 500 is virtually indicated. In addition, the color of the indicator lamp icon 382 changes with the expansion and contraction of the virtual bar display 383, whereby a change in the lighting state of the indicator lamp 52 with the increase and decrease of the level Y is virtually indicated.

In addition, while the indicator lamp pattern setting screen 380 is displayed on the display portion 20, the indicator lamp 52 may actually be turned on, and the actual lighting color of the indicator lamp 52 may change in conjunction with the change in color of the indicator lamp icon 382. That is, the actual lighting color of the indicator lamp 52 is preferably changed in conjunction with the movement of the animation image displayed on the indicator lamp pattern setting screen 380. By linking the animation image of the indicator lamp pattern setting screen 380 with the indicator lamp 52, the user can easily visually grasp how the lighting state of the indicator lamp 52 changes with the increase or decrease of the level Y.

The color-coding pattern of each section of the virtual color gauge 385 changes according to the pattern name displayed in the indicator lamp pattern setting field 381. FIG. 24 illustrates a color-coding pattern in “pattern 2” (second indicator lamp pattern). In FIG. 24, the uppermost section and the lowermost section have the same color (for example, red). The second section from the top has a different color (for example, green) from the top section, and the third section from the top and the fourth section from the top also have the same color (for example, green) as the second section from the top. In FIG. 24, the virtual bar arrow 384 indicates the lower end of the uppermost section, and the indicator lamp icon 382 has the same color (for example, red) as the uppermost section.

Even when the pattern name displayed in the indicator lamp pattern setting field 381 is changed, the movement of the animation image continues. When the color-coding of the sections is changed along with the change of the pattern name, the color of the section indicated by the virtual bar arrow 384 changes, and accordingly, the lighting colors of the indicator lamp icon 382 and the indicator lamp 52 may change.

When the user operates the determination key (center key 39) on the indicator lamp pattern setting screen 380, the setting unit 61 sets the color-coding pattern of the virtual color gauge 385 corresponding to the pattern name displayed in the indicator lamp pattern setting field 381 as the changing pattern of the lighting state of the indicator lamp 52 according to the increase or decrease of the level Y. Specifically, the setting unit 61 divides the level Y to be measured into a plurality of level ranges according to the set numerical value of the threshold, and assigns the color of each section of the virtual color gauge 385 to each level range.

Note that each section of the virtual color gauge 385 is not necessarily color-coded, and for example, all sections may have the same color pattern. In addition, the change in the lighting state of the indicator lamp 52 indicated by the indicator lamp icon 382 includes not only the change in the lighting color but also the change to the light-off state and the blinking state. Depending on the pattern, at least one of the sections of the virtual color gauge 385 may be displayed corresponding to the state in which the indicator lamp 52 is turned off or the state in which the indicator lamp 52 blinks. Then, the indicator lamp icon 382 may indicate the light-off state or the blinking state of the indicator lamp 52 according to the expansion and contraction of the virtual bar display 383. Further, the actual lighting state of the indicator lamp 52 is preferably changed in conjunction with the change in the lighting state (including lighting color, light-off state, and blinking state) of the indicator lamp icon 382.

In addition, the option of the indicator lamp pattern may be not only a predetermined pattern but also a pattern that can be independently set by the user. For example, when the determination key (center key 39) is operated in a state where “custom” is displayed in the indicator lamp pattern setting field 381, the display of the display portion 20 may transition to a custom pattern setting screen (not illustrated) on which the user can independently set the pattern of the lighting state of the indicator lamp 52.

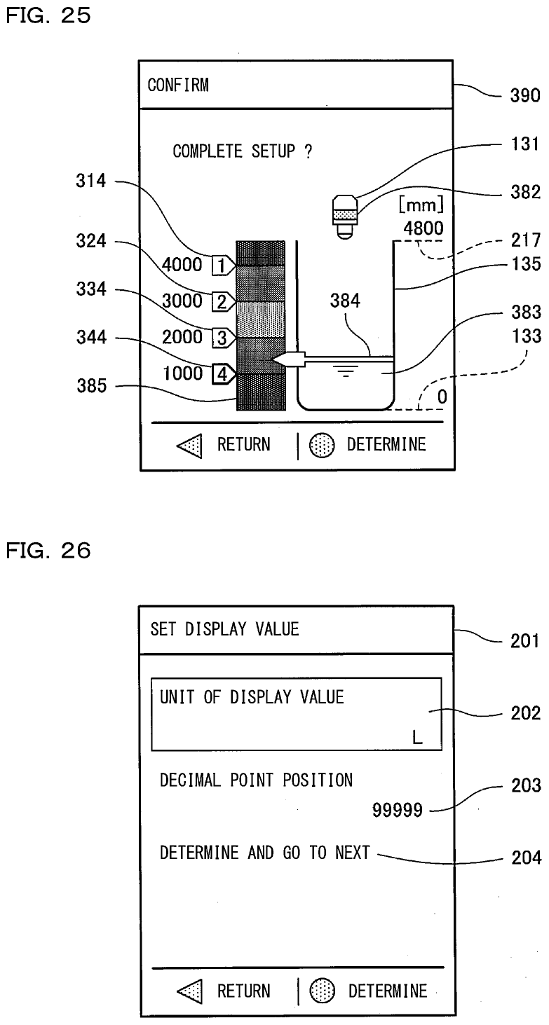

When the changing pattern of the lighting state of the indicator lamp 52 is set on the indicator lamp pattern setting screen 380, the display of the display portion 20 transitions to the setup completion confirmation screen 390 illustrated in FIG. 25. When the determination key (center key 39) is operated on the setup completion confirmation screen 390, the initial setting 100 is completed, and the contents set on the individual setting screens of the initial setting 100 are collectively stored in the storage unit 63. Thereafter, the level meter 10 transitions to the measurement mode 500 of FIG. 7.

The setup completion confirmation screen 390 of FIG. 25 includes a level meter icon 131, a container bottom line 133, a container icon 135, a container upper surface line 217, a virtual bar display 383, a virtual bar arrow 384, and a virtual color gauge 385. The level meter icon 131 includes the indicator lamp icon 382. In addition, a first threshold identifier 314, a second threshold identifier 324, a third threshold identifier 334, and a fourth threshold identifier 344 are displayed next to the virtual bar display 383. Above the container bottom line 133, the value (0) of the level Y at the bottom of the container 70 is displayed. Above the container upper surface line 217, the height value (4800) of the container 70 is displayed. Further, instead of the height of the container 70, the distance from the level meter 10 to the bottom of the container 70 may be displayed.

On the setup completion confirmation screen 390, numerical values of a plurality of thresholds (level setting values) set by the setting unit 61 in the initial setting 100 are collectively displayed. Specifically, as illustrated in FIG. 25, together with the first threshold identifier 314, the second threshold identifier 324, the third threshold identifier 334, and the fourth threshold identifier 344 individually allocated to the threshold, a numerical value of the first threshold (here, 4000), a numerical value of the second threshold (here, 3000), a numerical value of the third threshold (here, 2000), and a numerical value of the fourth threshold (here, 1000) corresponding to these identifiers are displayed.

In addition, on the setup completion confirmation screen 390, the respective relative positions of the thresholds with respect to the container 70 are displayed together with the respective numerical values of the plurality of thresholds (level setting values). Specifically, as the ratio of the numerical values of the first threshold, the second threshold, the third threshold, and the fourth threshold to the height value of the container 70 is higher, the first threshold identifier 314, the second threshold identifier 324, the third threshold identifier 334, and the fourth threshold identifier 344 are displayed at higher positions with respect to the container icon 135. That is, the relative positions of the first threshold identifier 314, the second threshold identifier 324, the third threshold identifier 334, and the fourth threshold identifier 344 with respect to the container icon 135 indicate the relative positions of the first threshold, the second threshold, the third threshold, and the fourth threshold with respect to the container 70.

On the setup completion confirmation screen 390, the relative position of each threshold (level setting value) with respect to the container 70 is displayed on the display portion 20, and the height value of the container 70 (here, 4800 mm) is also displayed. Note that the bottom distance Y₀ may be displayed instead of the height of the container 70. In this manner, on the setup completion confirmation screen 390, the container information and the level setting value set in the initial setting 100 are collectively displayed. By checking the setup completion confirmation screen 390, the user can confirm whether the setting item in the initial setting 100 has been correctly set.

Furthermore, on the setup completion confirmation screen 390, an animation image indicating a change in the operation of the level meter 10 with the increase or decrease of the level Y is displayed on the indicator lamp pattern setting screen 380. This animation image includes a virtual bar display 383 and an indicator lamp icon 382. Specifically, on the setup completion confirmation screen 390, the virtual bar display 383 repeats expansion and contraction similarly to the indicator lamp pattern setting screen 380. Then, as the virtual bar display 383 expands and contracts, the lighting state of the indicator lamp icon 382 changes.

In addition, on the setup completion confirmation screen 390, as an example of a change in the operation of the level meter 10 accompanying the increase or decrease of the level Y, a change in the output signal of the external output terminal 12D may also be confirmed. Specifically, when the output signal of the external output terminal 12D corresponding to each threshold is enabled as the level Y increases or decreases, the identifier assigned to each threshold may be highlighted. In addition, the signal output from the external output terminal 12D may actually change.

For example, assuming that the characteristics (output logic) of the first threshold, the second threshold, the third threshold, and the fourth threshold are all normally open in FIG. 25, while virtual bar arrow 384 indicates below the fourth threshold identifier 344, all the signals of the external output terminal 12D corresponding to the first threshold, the second threshold, the third threshold, and the fourth threshold are invalid (open, OFF). Then, as illustrated in FIG. 25, when the virtual bar display 383 extends and the virtual bar arrow 384 indicates above the fourth threshold identifier 344 (the level Y virtually exceeds the fourth threshold), only the signal of the external output terminal 12D corresponding to the fourth threshold is enabled (close, ON). In FIG. 25, in order to indicate that the signal of the external output terminal 12D corresponding to the fourth threshold is enabled, the frame of the fourth threshold identifier 344 is highlighted as a thick frame. On the other hand, since the signals of the external output terminal 12D corresponding to the first threshold, the second threshold, and the third threshold remain invalid, the frames of the first threshold identifier 314, the second threshold identifier 324, and the third threshold identifier 334 remain in the normal state. Thereafter, as the virtual bar display 383 extends, the third threshold identifier 334, the second threshold identifier 324, and the first threshold identifier 314 are sequentially highlighted.

As described above, the animation image showing the change in the operation of the level meter 10 with the increase or decrease of the level Y is displayed on the setup completion confirmation screen 390, so that the user can visually grasp how the operation of the level meter 10 changes with the increase or decrease of the level Y. Therefore, the user can confirm whether the setting contents performed in the initial setting 100 are appropriate before the setting contents are actually applied.

Next, the display in the display portion 20 in a case where “ON” is selected on the scaling confirmation screen 160 illustrated in FIG. 16 and the scaling setting 200 is performed will be described. In a case where the scaling setting 200 is performed, first, the display value setting screen 201 illustrated in FIG. 26 is displayed on the display portion 20.

The display value setting screen 201 includes an option of the unit setting screen 202, an option of the decimal point position setting screen 203, and an option 204 for proceeding to the next setting. Further, a character string (“L”, “99999”, etc.) indicating the setting contents set on the unit setting screen 202 and the decimal point position setting screen 203 is also displayed in each option.

In response to the user's selection, the display in the display portion 20 transitions from the display value setting screen 201 to the unit setting screen 202 or the decimal point position setting screen 203. Although details of the unit setting screen 202 are not illustrated, options of units of display values such as m, mm, L, g, and % are displayed on the unit setting screen 202, and the unit of the option selected by the user is set as the unit of the display value.

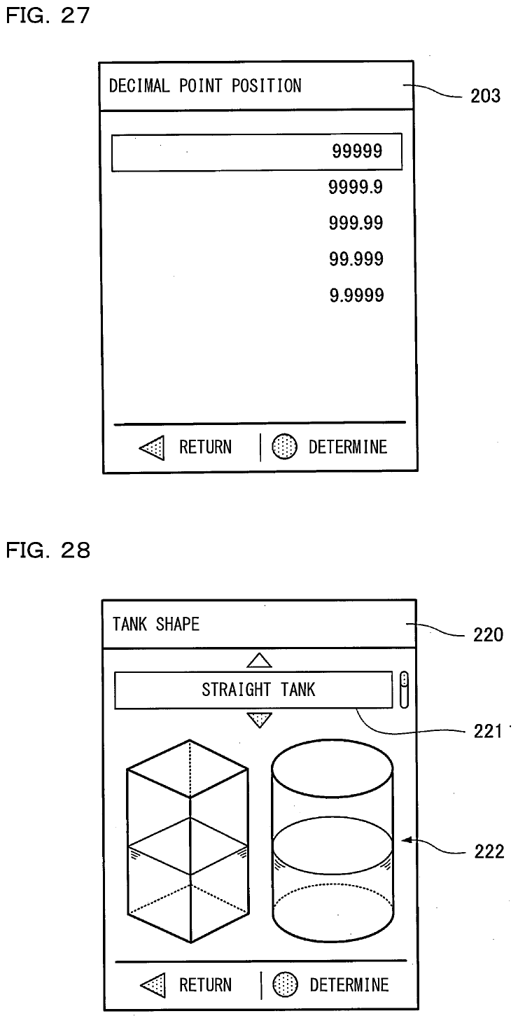

FIG. 27 illustrates a decimal point position setting screen 203. On the decimal point position setting screen 203, a plurality of display examples (“99999”, “9999.9”, “999.99”, “99.999”, and “9.9999”) having different decimal point display positions are displayed. When the display example corresponding to the display position of the decimal point desired by the user is selected, the number of digits of the integer part and the number of digits of the fractional part are set for the measurement value displayed on the auxiliary display portion 26 of the display portion 20 in the measurement mode 500.

When the option 204 for proceeding to the next setting is selected on the display value setting screen 201, the display of the display portion 20 transitions to a tank shape setting screen 220 illustrated in FIG. 28. The tank shape of the container 70 is set on the tank shape setting screen 220. The tank shape is treated as part of the container information on the container 70. The tank shape setting screen 220 includes a tank shape setting field 221 and a tank shape display field 222.

In the tank shape setting field 221, the name of the tank shape is displayed. When the down key 35 and the up key 36 are operated by the user on the tank shape setting screen 220, the names displayed in the tank shape setting field 221 are switched. In FIG. 28, “straight tank” is displayed as the name of the tank shape.

The tank shape display field 222 shows an illustration of a tank shape corresponding to the name indicated in the tank shape setting field 221. In FIG. 28, illustrations of a vertical cylindrical tank and a quadrangular prismatic tank are shown as the tank shape of the “straight tank”.

When the determination key (center key 39) is operated on the tank shape setting screen 220, the tank shape having the name indicated in the tank shape display field 222 is set as the tank shape of the container 70. Then, the display of the display portion 20 transitions to the bottom distance setting screen 211 and the upper surface distance setting screen 212 corresponding to the tank shape. Note that the bottom distance setting screen 211 and the upper surface distance setting screen 212 corresponding to the straight tank are similar to those illustrated in FIGS. 17 and 18.

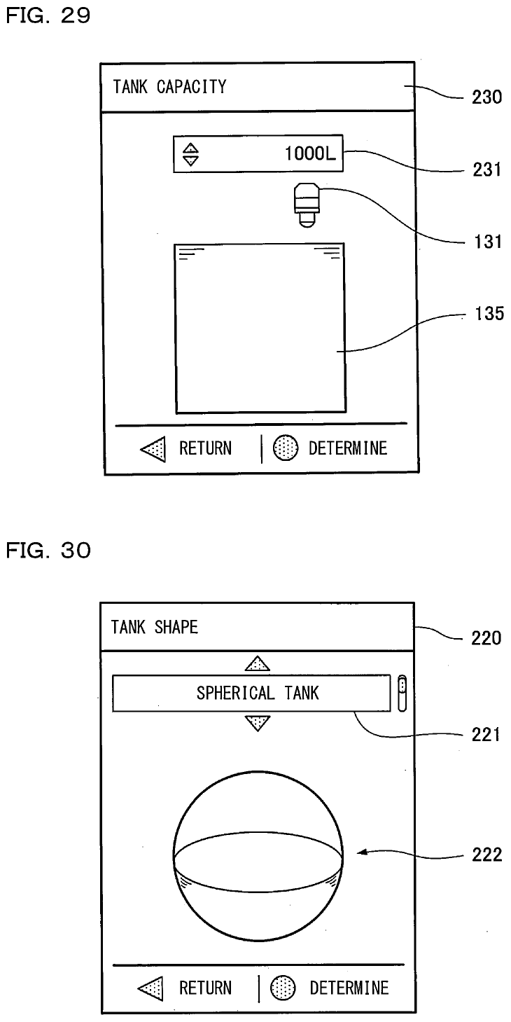

When the bottom distance Y₀ and the top distance Y₁ are set on the bottom distance setting screen 211 and the upper surface distance setting screen 212, the display of the display portion 20 transitions to the capacity setting screen 230 illustrated in FIG. 29. The capacity setting screen 230 in FIG. 29 corresponds to a straight tank.

The capacity setting screen 230 includes a level meter icon 131, a container icon 135, and a capacity setting field 231. The container icon 135 imitates a state (full state) in which the liquid is filled up to the position of the upper surface of the “straight tank”. In the capacity setting field 231, a candidate value of the full capacity value of the container 70 is displayed. The candidate value of the full capacity value is displayed as a volume value (for example, L: liter). When the down key 35 and the up key 36 are operated on the capacity setting screen 230, the numerical value displayed in the capacity setting field 231 increases or decreases. When the determination key (center key 39) is operated on the capacity setting screen 230, the numerical value displayed in the capacity setting field 231 is set as the full capacity value (tank capacity) of the container 70. The tank capacity is treated as part of the container information on the container 70.

Next, a case where the shape of the container 70 is other than “straight tank” will be described. FIG. 30 illustrates a case where the name (option) of the tank shape displayed in the tank shape setting field 221 on the tank shape setting screen 220 is “spherical tank”. In FIG. 30, an illustration of the spherical tank is shown in the tank shape display field 222.

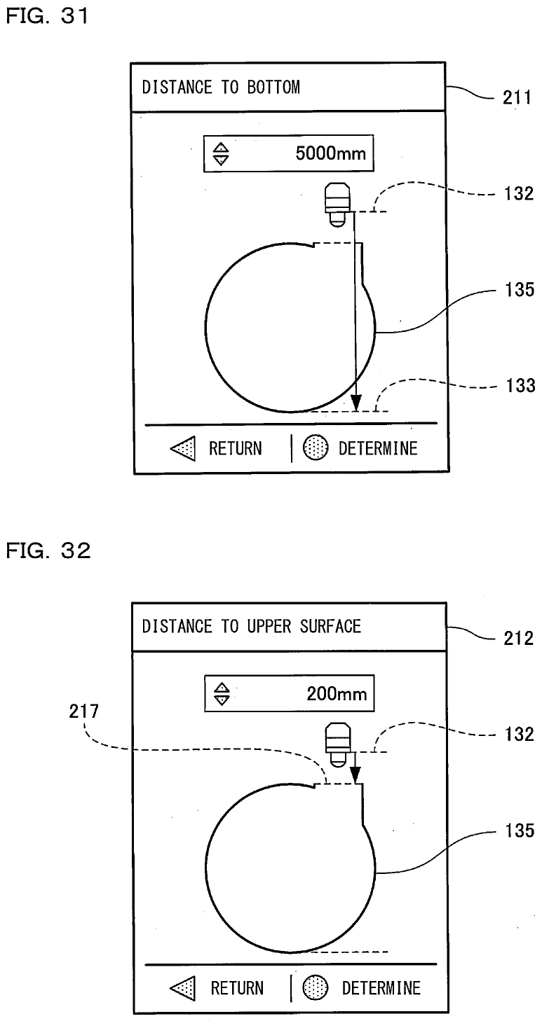

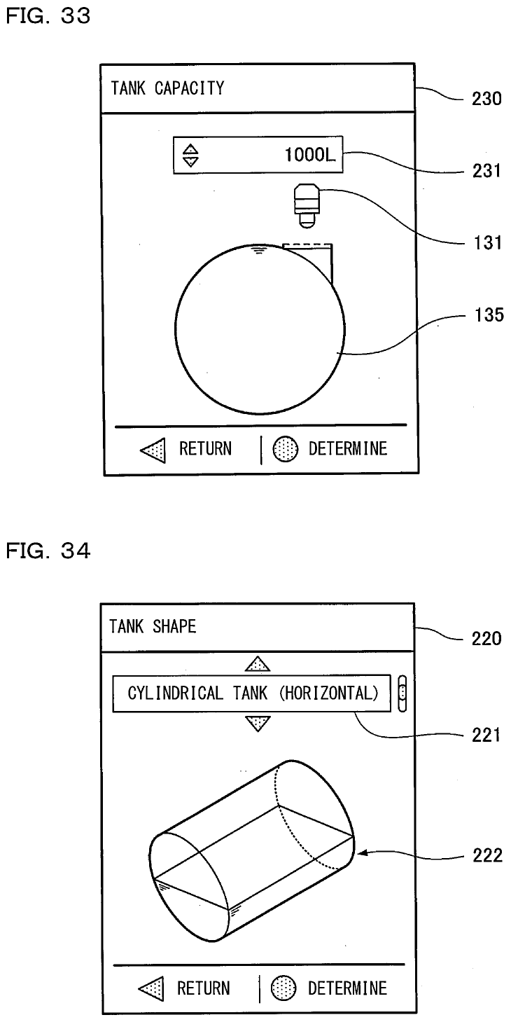

Even in a case where the spherical tank is selected as the tank shape, setting of the bottom distance Y₀ by the bottom distance setting screen 211, setting of the upper surface distance Y₁ by the upper surface distance setting screen 212, and setting of the tank capacity by the capacity setting screen 230 are performed. FIG. 31 is a view illustrating a bottom distance setting screen 211 of the spherical tank. FIG. 32 is a view illustrating an upper surface distance setting screen 212 of the spherical tank. FIG. 33 is a view illustrating a capacity setting screen 230 of the spherical tank. As illustrated in FIGS. 31, 32, and 33, in a case where the tank shape is a spherical tank, the shape of the container icon 135 is different from that of a straight tank. Further, even in the case of other tank shapes, the shape of the container icon 135 displayed at the time of setting the container information corresponds to the selected tank shape.

Even in a case where the tank shape is a spherical tank, the bottom distance Y₀ corresponding to the distance from the measurement reference surface line 132 to the container bottom line 133 is set by the bottom distance setting screen 211 (FIG. 31). In addition, the upper surface distance Y₁ corresponding to the distance from the measurement reference surface line 132 to the container upper surface line 217 is set by the upper surface distance setting screen 212 (FIG. 32). In the spherical tank, the container bottom line 133 is a line extending horizontally from the lower end of the spherical tank. In the spherical tank, the container upper surface line 217 is a line extending horizontally from the upper end of the spherical tank.

In a case where the tank shape is a spherical tank, the relationship between the measured level Y and the volume of the object 72 in the container 70 is not a simple proportional relationship. The level meter 10 can calculate a relationship between the measured level Y and the volume of the object 72 in the container 70 based on the set bottom distance Y₀, upper surface distance Y₁, and tank capacity and the fact that the tank (container 70) is spherical.

FIG. 34 illustrates a case where the name (option) of the tank shape displayed in the tank shape setting field 221 on the tank shape setting screen 220 is “cylindrical tank (horizontal placement)”. In FIG. 34, an illustration of a horizontal cylindrical tank is shown in the tank shape display field 222.

Even in a case where a horizontal cylindrical tank is selected as the tank shape, setting of the bottom distance Y₀ by the bottom distance setting screen 211, setting of the upper surface distance Y₁ by the upper surface distance setting screen 212, and setting of the tank capacity by the capacity setting screen 230 are performed. Based on these setting contents and the fact that the tank shape is a horizontal cylindrical tank, the level meter 10 can calculate the relationship between the measured level Y and the volume of the object 72 in the container 70.

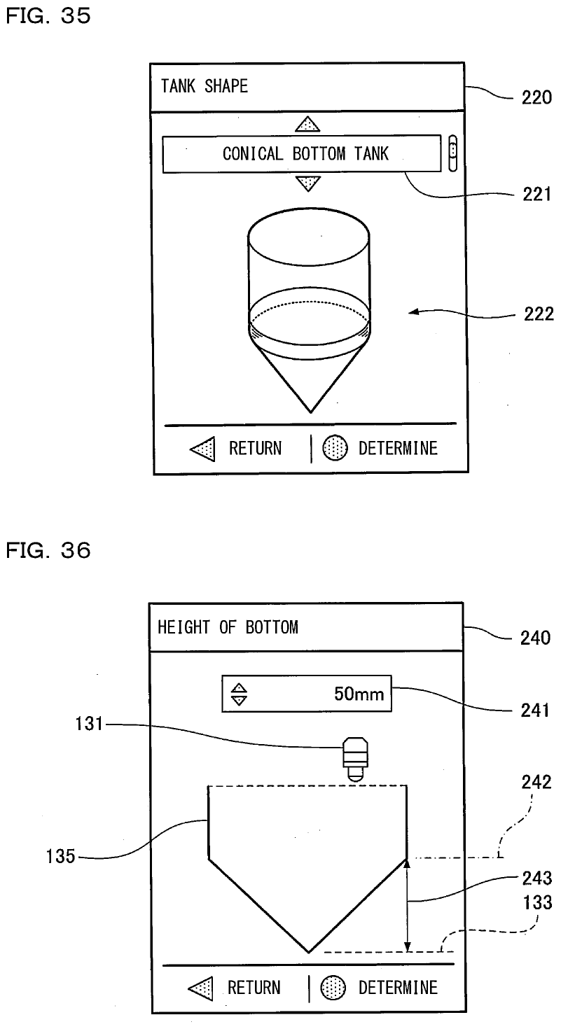

FIG. 35 illustrates a case where the name (option) of the tank shape displayed in the tank shape setting field 221 on the tank shape setting screen 220 is “conical bottom tank”. In FIG. 35, an illustration of a conical bottom tank is shown in the tank shape display field 222.

In a case where the conical bottom tank is selected as the tank shape, the bottom height setting screen 240 illustrated in FIG. 36 is displayed on the display portion 20 after the setting of the bottom distance Y₀ by the bottom distance setting screen 211 and the setting of the upper surface distance Y₁ by the upper surface distance setting screen 212 and before the setting of the tank capacity by the capacity setting screen 230.

The bottom height setting screen 240 includes a level meter icon 131, a container bottom line 133, a container icon 135, a bottom height setting field 241, and a bottom height arrow 243. On the bottom height setting screen 240, the height of the conical portion of the conical bottom tank lower portion is set. The distance from the bottom of the conical bottom tank to the boundary between the conical portion and the cylindrical portion is the height of the conical portion. Hereinafter, the height of the conical portion may also be referred to as a height of the bottom or a bottom height. The bottom height arrow 243 displayed on the bottom height setting screen 240 indicates that the height of the bottom portion is set. For the sake of explanation, FIG. 36 illustrates a conical portion boundary line 242 extending horizontally from the boundary between the conical portion and the cylindrical portion of the container icon 135. The conical portion boundary line 242 is not displayed on the bottom height setting screen 240. The bottom height arrow 243 indicates the spacing between the container bottom line 133 and the conical portion boundary line 242.

A candidate value of the bottom height is displayed in the bottom height setting field 241. When the down key 35 and the up key 36 are operated on the bottom height setting screen 240, the numerical value displayed in the bottom height setting field 241 increases or decreases. When the determination key (center key 39) is operated on the bottom height setting screen 240, the numerical value displayed in the bottom height setting field 241 is set as the bottom height (the height of the conical portion) of the container 70. The bottom height is treated as part of the container information for the container 70.

When the bottom height of the conical bottom tank is set, the capacity setting screen 230 is subsequently displayed on the display portion 20, and the tank capacity is set. The level meter 10 can calculate a relationship between the measured level Y and the volume of the object 72 in the container 70 based on the set bottom distance Y₀, top distance Y₁, bottom height, and tank capacity and the fact that the tank (container 70) is a conical bottom tank.

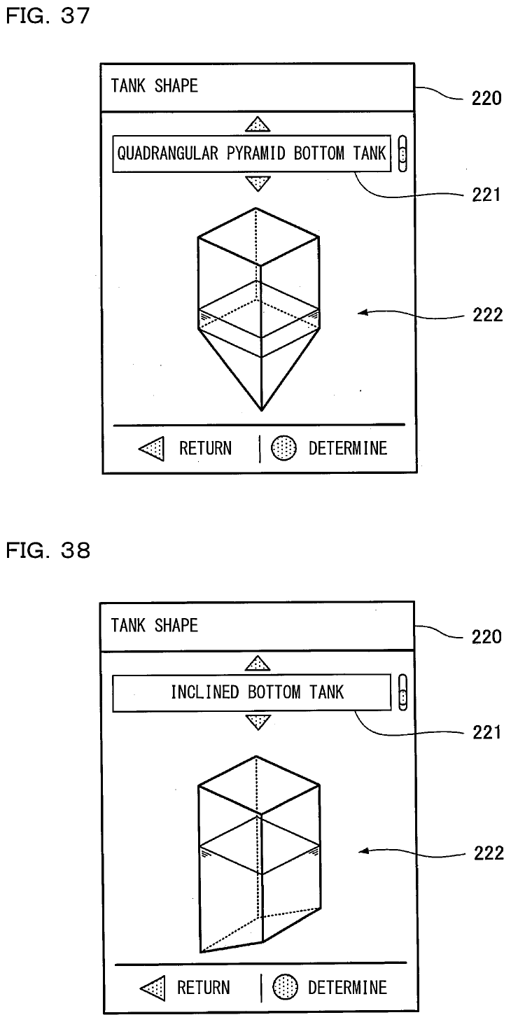

FIG. 37 illustrates a case where the name (option) of the tank shape displayed in the tank shape setting field 221 on the tank shape setting screen 220 is “quadrangular pyramid bottom tank”. In FIG. 37, an illustration of a quadrangular pyramid bottom tank is shown in the tank shape display field 222. In a case where the quadrangular pyramid bottom tank is selected as the tank shape, the bottom height (height of the conical portion) of the container 70 is set by the bottom height setting screen 240 as in the case of the conical bottom tank.

FIG. 38 illustrates a case where the name (option) of the tank shape displayed in the tank shape setting field 221 on the tank shape setting screen 220 is “inclined bottom tank”. In FIG. 38, an illustration of the inclined bottom tank is shown in the tank shape display field 222. In a case where the inclined bottom tank is selected as the tank shape, the bottom height of the container 70 is set by the bottom height setting screen 240 as in the case of the conical bottom tank. Further, the bottom height of the inclined bottom tank is the height of the inclined portion of the inclined bottom tank lower portion.

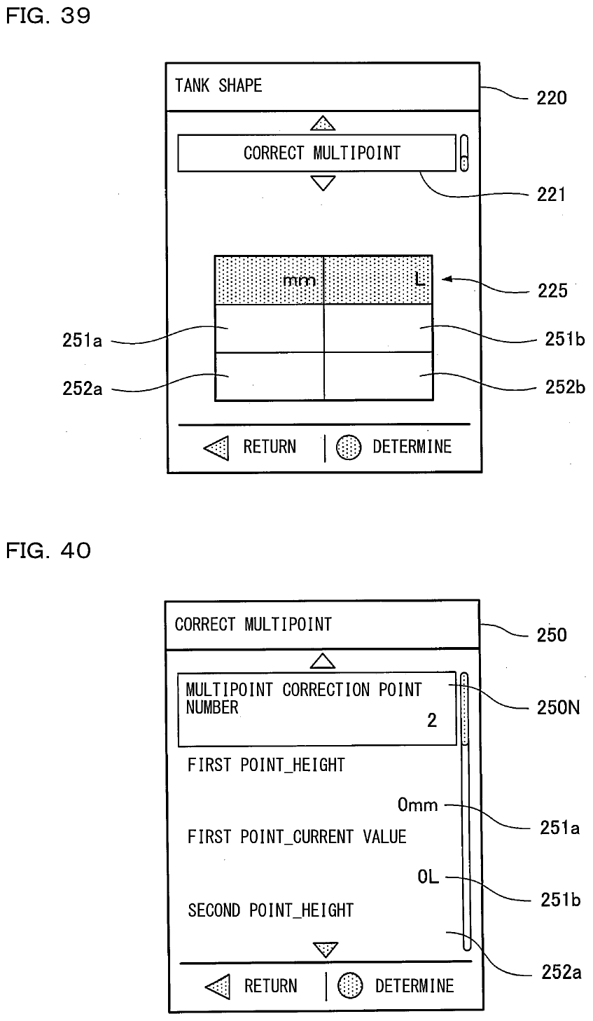

FIG. 39 illustrates a case where the name (option) of the tank shape displayed in the tank shape setting field 221 on the tank shape setting screen 220 is “multipoint correction”. In a case where the multipoint correction options are displayed, a multipoint correction table 225 is displayed instead of the tank shape display field 222. The multipoint correction table 225 is a table showing setting of correction points determined by a combination of the value of the level Y of the object 72 and the value of the volume of the object 72 corresponding to the value in the tank having a complicated shape. In FIG. 39, fields of a first correction point height 251a, a first correction point volume 251b, a second correction point height 252a, and a second correction point volume 252b are displayed.

In a case where multipoint correction is selected on the tank shape setting screen 220, the multipoint correction screen 250 illustrated in FIG. 40 is displayed on the display portion 20 instead of the capacity setting screen 230 after the bottom distance setting screen 211 and the upper surface distance setting screen 212. Although the shape of the container 70 is complicated in a case where the multipoint correction is used, it is preferable to use an existing container icon 135 such as a straight tank as the container icon 135 on the bottom distance setting screen 211 and the upper surface distance setting screen 212.

The multipoint correction screen 250 displays a multipoint correction point number 250N and the height and volume of each correction point. In FIG. 40, a first correction point height 251a, a first correction point volume 251b, and a second correction point height 252a are displayed. When the down key 35 and the up key 36 are operated to scroll the multipoint correction screen 250, other values such as the second correction point volume 252b not illustrated in FIG. 40 are also displayed.

When the multipoint correction point number 250N is selected on the multipoint correction screen 250, the display portion 20 transitions to a correction point number setting screen (not illustrated). On the correction point number setting screen, the number of correction points is set. The number of correction points may be selected from predetermined numerical values of options (for example, 2 to 32).

When the height or volume of each correction point such as the first correction point height 251a and the first correction point volume 251b is selected on the multipoint correction screen 250, the display portion 20 transitions to a screen (not illustrated) for setting the height or volume of each correction point. On the screen for setting the height of the correction point, the value of the height of the correction point is set within the range of the height of the container 70. On the screen for setting the volume of the correction point, the value of the volume of the object 72 when the level Y of the object 72 reaches the height of the correction point is set. Based on the setting of these correction points, the level meter 10 can calculate the relationship between the measured level Y and the volume of the object 72 in the container 70. Note that, in a case where the display of the display portion 20 is returned to the tank shape setting screen 220 after each correction point is set on the multipoint correction screen 250, the numerical value of each set correction point is preferably displayed in the multipoint correction table 225.

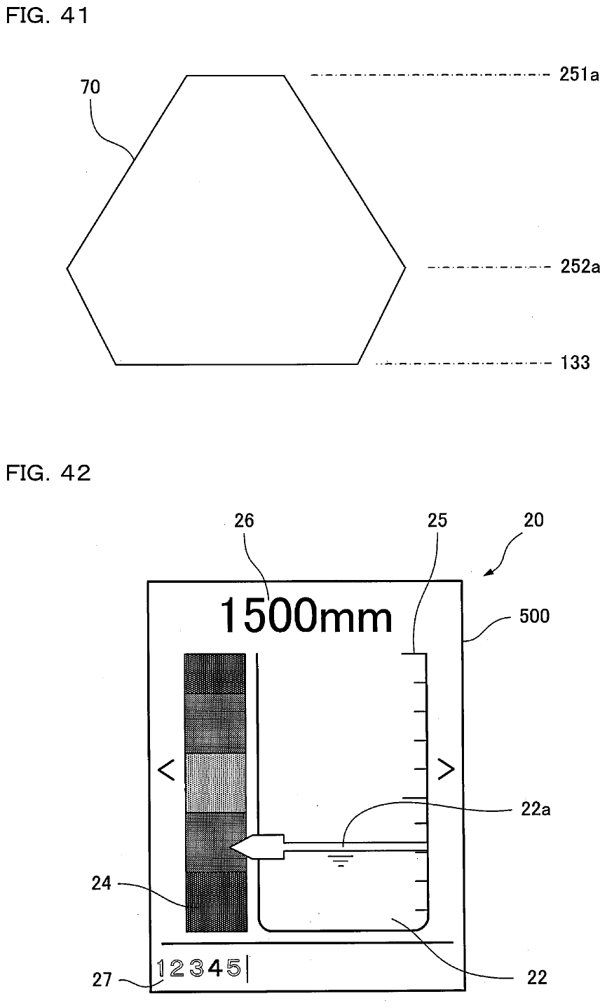

FIG. 41 illustrates an example of a tank shape (shape of the container 70) corresponding to the multipoint correction. FIG. 41 is a schematic cross-sectional view of the container 70. The container 70 has a shape in which the height of the upper end portion is the first correction point height 251a and the lateral width increases until reaching the lower second correction point height 252a. Then, a portion between the second correction point height 252a and the container bottom line 133 has a shape in which the lateral width is narrowed. In such a container 70, the value of the level Y and the volume of the object 72 are not in a simple proportional relationship.

Here, if the volume of the object 72 corresponding to the first correction point height 251a (first correction point volume 251b) and the volume of the object 72 corresponding to the second correction point height 252a (second correction point volume 252b) are set, the level meter 10 can calculate the volume of the object 72 at an arbitrary level Y by assuming that the lateral width of the container 70 linearly changes between the correction points. Then, even in a case where the container 70 has a more complicated shape, if a large number (for example, 32 points) of correction points are set, the level meter 10 can calculate a value corresponding to the actual volume of the object 72 for an arbitrary level Y.

When the setting on the capacity setting screen 230 or the multipoint correction screen 250 is completed, the scaling setting 200 is completed. Thereafter, the display content of the display portion 20 passes through a setting screen of each threshold (such as the first threshold setting screen 310), the indicator lamp pattern setting screen 380, and the setup completion confirmation screen 390, and the initial setting 100 of the level meter 10 is completed. The level meter 10 in which the initial setting 100 is completed transitions to the measurement mode 500 (FIG. 7).

FIG. 42 illustrates an example of the display portion 20 in the measurement mode 500. The display portion 20 in the measurement mode 500 displays a bar display 22, a color gauge 24, an auxiliary display portion 26, and an output state display portion 27.

The length of the bar display 22 expands and contracts according to the value of the level Y measured by the level meter 10 (determined by the level determination unit 88). A bar arrow 22a is displayed at the upper end of the bar display 22. In addition, the bar display 22 expands and contracts in the container icon 25 imitating the container 70. On the container icon 25, scales for equally dividing the length of the container icon 25 (10 divisions in FIG. 42) along the length direction of the container icon 25 are displayed. By checking the position of the bar arrow 22a and the scale of the container icon 25, the user can easily visually grasp the ratio of the current level Y with respect to the entire container 70 (relative position with respect to the container 70).

The color gauge 24 is displayed side by side with the container icon 25 including the bar display 22. The length direction of the color gauge 24 is along the expansion/contraction direction of the bar display 22. In addition, the color gauge 24 includes a plurality of sections (5 sections in FIG. 42), and these sections are arranged along the expansion/contraction direction of the bar display 22. The bar arrow 22a indicates a position in the color gauge 24 corresponding to the length of the bar display 22.

The color gauge 24 is color-coded for each section. The indicator lamp 52 of the level meter 10 is lit in the same color as the color of the section indicated by the bar arrow 22a. The lighting color of the indicator lamp 52 is not necessarily exactly the same as the color of the section indicated by the bar arrow 22a, and the lighting state of the indicator lamp 52 may correspond to the color of the section indicated by the bar arrow 22a. For example, in a case where the section indicated by the bar arrow 22a has a color (for example, black) corresponding to the light-off state, the indicator lamp 52 may be turned off.

The color-coding pattern of the color gauge 24 matches the color-coding pattern of the virtual color gauge 385 when the indicator lamp pattern is set on the indicator lamp pattern setting screen 380 (FIG. 22). Further, depending on the indicator lamp pattern, the color gauge 24 may not be color-coded because all the sections have the same color or include the section in the light-off state. Note that, even in a case where the gauges are not color-coded, division for each section is performed by displaying a boundary line of the section or the like.

The color gauge 24 indicates a relative position of the threshold (level setting value) with respect to the container 70. The position of the boundary of each section of the color gauge 24 is determined based on the container information and the threshold set in the initial setting 100. Specifically, the magnitude of the difference between the thresholds corresponds to the size of each section, and the ratio of each threshold to the height of the container 70 (one of the container information) corresponds to the position of the boundary of each section with respect to the entire length of the container icon 25. By checking the boundary between the container icon 25 and each section of the color gauge 24, the user can easily visually grasp the relative position of the set threshold (level setting value) with respect to the container 70.

As described above, in the display portion 20 in the measurement mode 500, the relative position of the level setting value with respect to the container 70 is displayed together with the bar display 22 whose length expands and contracts according to the value of the level Y based on the level Y determined by the level determination unit 88, the container information, and the level setting value.

The auxiliary display portion 26 displays a numerical value based on the level Y determined (measured) by the level determination unit 88. In FIG. 42, the numerical value (height) of the measured level Y is displayed in mm. In a case where the scaling setting 200 is performed in the initial setting 100, the display format of the auxiliary display portion 26 is based on the setting contents on the display value setting screen 201 (FIG. 26).

For example, in a case where L (liter) is selected as the unit of the display value, the volume of the object 72 in the container 70 is displayed in L as the unit on the auxiliary display portion 26. In this case, the volume of the object 72 is calculated based on the measured level Y and the container information set in the initial setting 100.

Further, in the measurement mode 500, the display format of the auxiliary display portion 26 may be changeable according to the user's operation. For example, when the user operates the right key 37 or the left key 38 in the measurement mode 500, the display format of the auxiliary display portion 26 may be switched to a height (mm), a volume (L), a ratio (%) with respect to a full capacity value, and the like.

The output state display portion 27 displays the state of the signal line in the external output terminal 12D in which the output changes depending on the relationship between the measured level Y and the threshold (level setting value). How the state of the signal line changes depending on the relationship between the level Y and the threshold is determined by setting contents on the output logic setting screen 315 (FIG. 20) related to each threshold. For example, in a case where “normally open” is selected on the output logic setting screen 315 for all the four thresholds, the signal of the signal line corresponding to the threshold is enabled when the level Y exceeds the threshold. In FIG. 42, the bar arrow 22a indicates the fourth section from the top of the color gauge 24. That is, the value of the level Y exceeds the fourth threshold from the top. On the other hand, the value of the level Y is smaller than the first, second, and third thresholds from the top. In the output state display portion 27 of FIG. 42, only the numeral “4” is highlighted (black display), and the other numerals are not highlighted (white display). This indicates that only the signal line corresponding to the fourth threshold is enabled (outputting a signal).

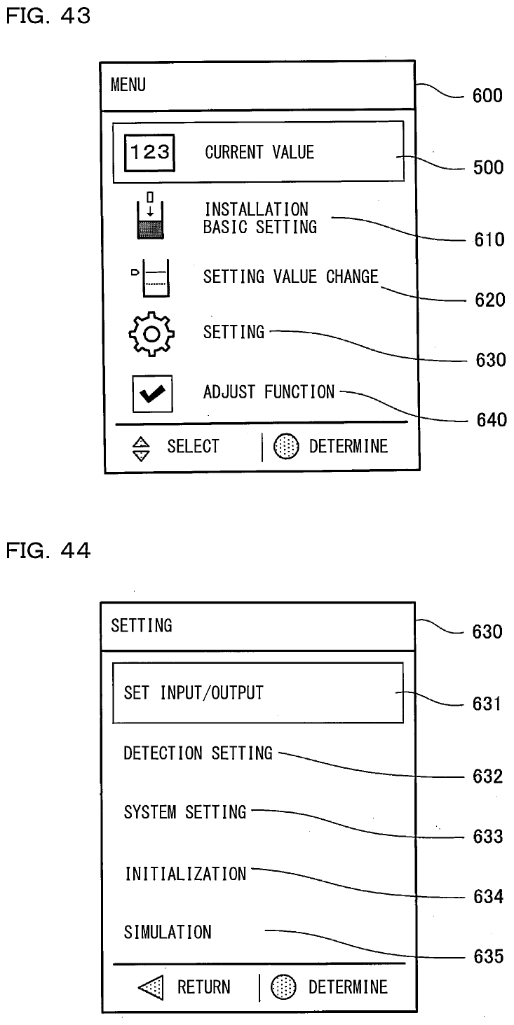

As also illustrated in FIG. 7, the display of the display portion 20 can mutually transition between the display screen of the measurement mode 500 and the menu screen 600. For example, when the user operates the menu key 32 in the measurement mode 500, the display of the display portion 20 transitions to the menu screen 600 illustrated in FIG. 43.

The menu screen 600 includes options for transitioning to a display screen of the measurement mode 500 (a screen displaying the “current value” of the level Y). In addition, the menu screen 600 includes options for transitioning to individual setting screens such as a container setting screen 610, a setting value change screen 620, and a miscellaneous setting screen 630. In FIG. 43, in addition to these, options for transitioning to the screen of an adjusting function 640 are also included in the menu screen 600. On the screen of the adjusting function 640, determination as to whether the installation state of the level meter 10 is appropriate and adjustment of various settings according to the determination result are performed based on the stability of the reflection signal Rx received by the reception circuit 43R.

When an option (a character string of “installation basic setting” in FIG. 43) for transitioning to the container setting screen 610 is selected on the menu screen 600, the display portion 20 transitions to the container setting screen 610 (not illustrated). On the container setting screen 610, resetting processing of changing the container information already set in the operation setting 300 in the initial setting 100 or the container setting 210 (FIG. 9, FIG. 10) included in the scaling setting 200 is performed by the setting unit 61. In the resetting processing of the container information, a screen including a numerical value setting field, the level meter icon 131, the container icon 135, and the like, such as the bottom distance setting screen 211 (FIG. 17) and the upper surface distance setting screen 212 (FIG. 18) used in the initial setting 100, is displayed on the display portion 20.

When the resetting processing of the container information is performed, it is preferable that the relative position of the level Y with respect to the container 70 or the value of the level Y is displayed for the current level Y determined (measured) by the level determination unit 88. For example, in addition to the display of the bottom distance setting screen 211 and the upper surface distance setting screen 212, the bar display 22 indicating the relative position of the level Y with respect to the container 70 may be displayed in the container icon 135 similarly to the display portion 20 in the measurement mode 500. In addition, the value of the measured current level Y may be displayed as a character string (for example, a character string such as “current value 1500 mm”). The bar display 22 indicating the relative position of the current level Y and the character string indicating a numerical value may be displayed together. In addition, while the resetting processing is performed, the bar display 22 displayed on the display portion 20 and the character string indicating the numerical value may vary in real time according to the measurement value. Note that, on the container setting screen 610, the entire container information regarding the container 70 such as the tank shape may be set in addition to the bottom distance Y₀ and the upper surface distance Y₁.

Further, in the resetting processing, the value of the container information (bottom distance Y₀, upper surface distance Y₁, etc.) which has already been set may also be displayed on the display portion 20. In the resetting processing of the container information, the relative position of the current level Y with respect to the container 70, the value of the level Y, and the value of the container information that has already been set are displayed on the display portion 20, so that the user can set the container information to be set again while being conscious of the magnitude relationship between the value of the current level Y and the container information that has already been set.

When an option (a character string of “setting value change” in FIG. 43) for transitioning to the setting value change screen 620 is selected on the menu screen 600, the display portion 20 transitions to the setting value change screen 620 (not illustrated). On the setting value change screen 620, the resetting processing of changing the level setting value (threshold) already set in the operation setting 300 (FIG. 9) in the initial setting 100 is performed by the setting unit 61. In the resetting processing of the level setting value, a screen including a numerical value setting field, a level meter icon 131, a container icon 135, an identifier of each threshold, and the like is displayed on the display portion 20 as in the first threshold setting screen 310 (FIG. 19) and the second threshold setting screen 320 (FIG. 20) used in the initial setting 100.

Even when the resetting processing of the level setting value is performed, it is preferable that the relative position of the level Y with respect to the container 70 (such as the bar display 22) or the value of the level Y (such as a character string indicating a numerical value) is displayed on the display portion 20. In addition, the value of the threshold that has already been set may also be displayed on the display portion 20. By displaying these pieces of information, the user can set the level setting value to be set again while being conscious of the magnitude relationship between the value of the current level Y and the already set level setting value. Note that, in a case where there is a plurality of thresholds to be set again, it is preferable that only the display related to the threshold to be set be highlighted. For example, it is preferable that only the identifier of the threshold to be set and the threshold line be displayed brightly, and the identifier of the threshold other than the threshold to be set and the threshold line be displayed in a grayed out manner.

When an option (character string of “setting” in FIG. 43) for transitioning to the miscellaneous setting screen 630 is selected on the menu screen 600, the display portion 20 transitions to the miscellaneous setting screen 630 illustrated in FIG. 44. The miscellaneous setting screen 630 includes options for transitioning to individual setting screens such as an input/output setting screen 631, a detection setting screen 632, and a system setting screen 633. In FIG. 44, in addition to these, an option of performing initialization 634 and an option of performing simulation 635 are also included in the miscellaneous setting screen 630. When the option of performing the initialization 634 is selected, various setting values such as the container information and the threshold are reset to predetermined initial setting values. When the option of performing the simulation 635 is selected, a simulation is performed to confirm whether the level meter 10 operates according to the setting contents while virtually changing the value of the level Y measured by the level meter 10.

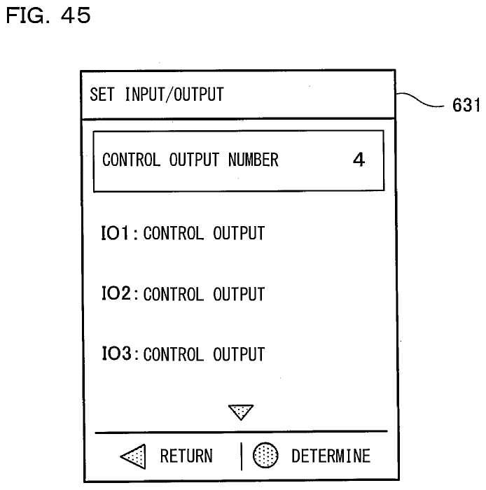

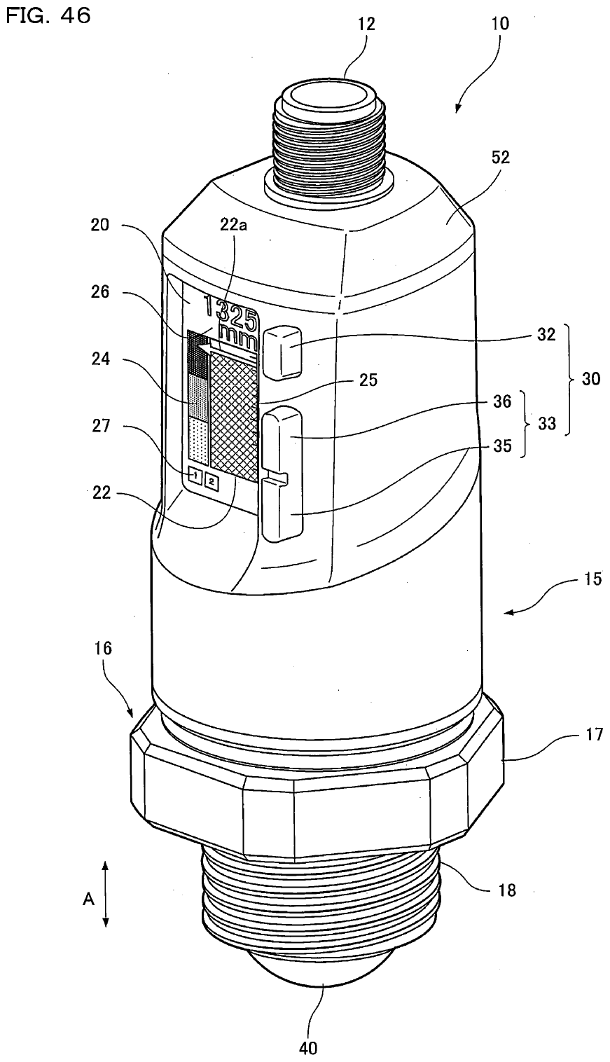

When an option of the input/output setting screen 631 is selected on the miscellaneous setting screen 630, the display portion 20 transitions to the input/output setting screen 631 illustrated in FIG. 45. On the input/output setting screen 631 transitioning from the miscellaneous setting screen 630, the characteristics of the external input terminal 12C and the external output terminal 12D in the connection portion 12 of the level meter 10 are set.

The input/output setting screen 631 in FIG. 45 includes an option of setting a value of the control output number and an option of setting characteristics of each terminal (signal line) of the connection portion 12. The value of the control output number indicates the number of the plurality of signal lines included in the connection portion 12 to be used as the external output terminal 12D for outputting a signal to the outside in the current measurement. The value of the control output number is the number of thresholds related to the level Y. When an option for setting the value of the control output number is selected, the display portion 20 displays a plurality of options indicating the number of signal lines that can be used as the external output terminal 12D, and allows the user to select one of the options.

When an option (a character string such as “IO1: control output”) for setting the characteristic of each terminal is selected, the display portion 20 transitions to a terminal characteristic setting screen (not illustrated). On the terminal characteristic setting screen, a numerical value (level setting value) of a threshold corresponding to each terminal (signal line), output logic (normally open or normally closed), and the like are set.

Note that the input/output setting screen 631 may include options of whether to enable an analog output terminal that outputs an analog value (for example, a current value of 4 to 20 mA), whether to use any terminal as a terminal for serial communication, whether to enable the external input terminal 12C, and whether to set characteristics of transistors used for the external output and the external input of the level meter 10 to PNP type or NPN type. For example, when the external input terminal 12C is enabled, the level meter 10 can receive setting information such as container information and a level setting value from the outside of the level meter 10 via the connection portion 12.

When an option of the detection setting screen 632 is selected on the miscellaneous setting screen 630 in FIG. 44, the display portion 20 transitions to the detection setting screen 632 (not illustrated). On the detection setting screen 632, a measurement condition (detection setting) of the level Y by the level meter 10 is set. The measurement condition of the level Y is, for example, container information such as a bottom distance Y₀ and an upper surface distance Y₁. As a measurement condition other than the container information, for example, there is a mask setting for ignoring the reflection signal Rx from a specific position in the container 70 in a specific measurement environment. As an example of the measurement environment in which the mask setting is necessary, there may be an element (for example, a device such as a stirrer provided in the container 70) that reflects the measurement signal Tx in the container 70 in addition to the interface 74 of the object 72. When the mask setting is necessary, the setting unit 61 sets a level setting value for the mask setting on the detection setting screen 632. Then, in a case where it is determined that the reflection signal Rx received by the reception circuit 43R is reflected at a position corresponding to the level setting value for the mask setting, the level determination unit 88 ignores the reflection signal Rx.

When an option of the system setting screen 633 is selected on the miscellaneous setting screen 630, the display portion 20 transitions to the system setting screen 633 (not illustrated). On the system setting screen 633, resetting processing of the setting items that are not set again on the container setting screen 610, the input/output setting screen 631, and the detection setting screen 632 is preferably performed. For example, on the system setting screen 633, resetting processing of the indicator lamp pattern set on the indicator lamp pattern setting screen 380 (FIG. 23), the display language set on the language setting screen 110 (FIG. 11), and the like is preferably performed. In addition, on the system setting screen 633, setting items that are not set in the initial setting 100, for example, screen brightness and the like may be set.

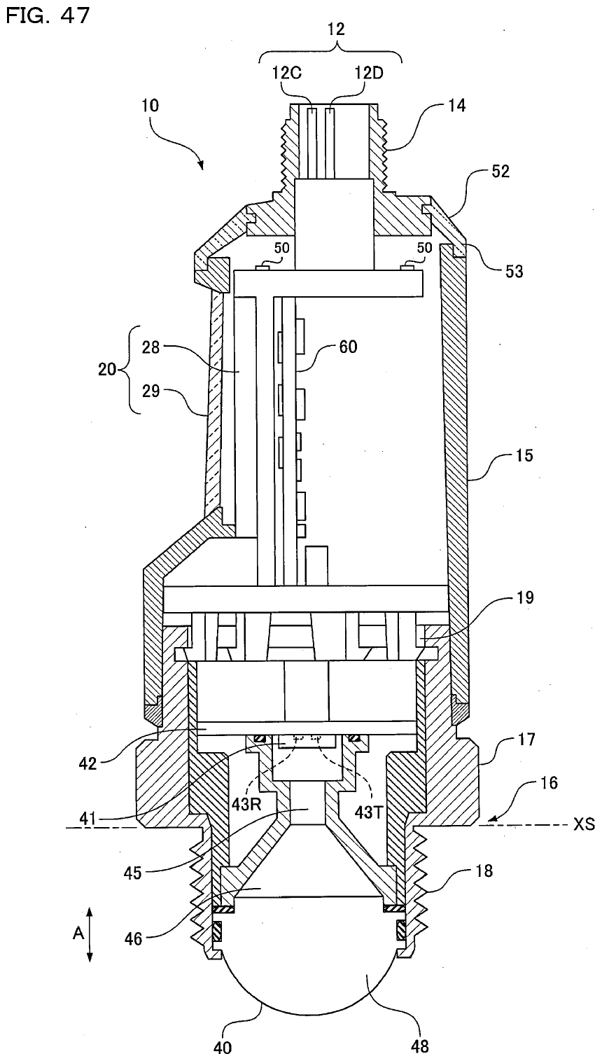

Next, another example of the level meter 10 will be described with reference to FIGS. 46 and 47. FIG. 46 is a perspective view illustrating another example of the level meter 10. FIG. 47 is a cross-sectional view of another example of the level meter 10. In FIGS. 46 and 47, components having the same functions as those of level meter 10 in FIGS. 1 and 2 are denoted by the same reference numerals as those in FIGS. 1 and 2, and the description thereof will not be repeated unless necessary.

In the level meter 10 of FIGS. 46 and 47, the housing 15 has a generally cylindrical shape extending in the longitudinal direction A. The housing 15 of FIGS. 46 and 47 has a function in which the base 15a and the terminal 21 of FIGS. 1 and 2 in the level meter 10 are integrated. The level meter 10 of FIGS. 46 and 47 has a smaller dimension than the level meter 10 in FIGS. 1 and 2.

In the level meter 10 in FIGS. 46 and 47, the connection portion 12 is provided on an upper side of the housing 15. The display portion 20 is disposed on an outer peripheral surface of the housing 15 extending along the longitudinal direction A. The indicator lamp 52 is provided between the connection portion 12 and the display portion 20 so as to surround the lower side (root) of the connection portion 12. As illustrated in FIG. 47, the state LED 50 and the transmission window 53 of the indicator lamp 52 are disposed above the display portion 20. The operation unit 30 is disposed adjacent to the display portion 20 and includes a menu key 32 and a direction key 33 arranged along the longitudinal direction A. In addition, the direction key 33 includes an up key 36 and a down key 35 arranged along the longitudinal direction A.

The display portion 20 of the level meter 10 in FIGS. 46 and 47 displays various types of information similarly to the display portion 20 of the level meter 10 in FIGS. 1 and 2. However, since the display portion 20 in FIGS. 46 and 47 is smaller than the display portion 20 in FIGS. 1 and 2, the display content may be simplified.

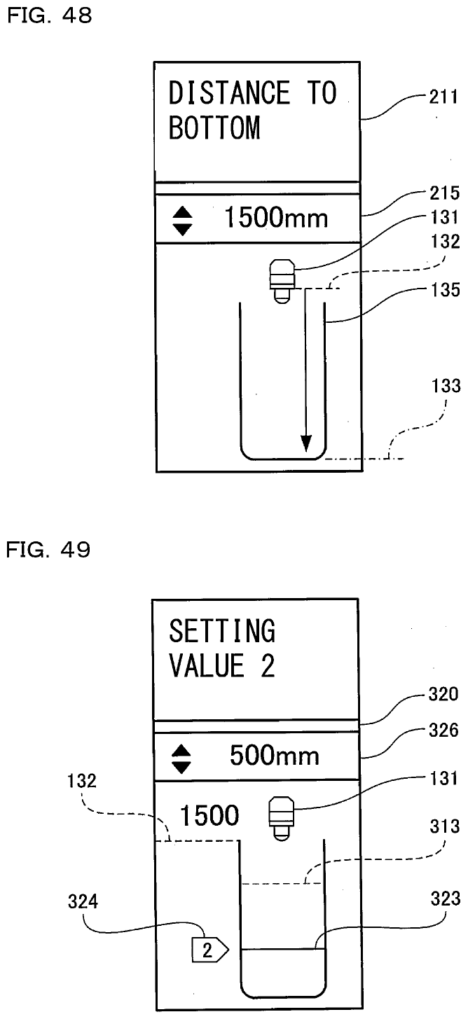

Hereinafter, some of the screens displayed on the display portion 20 of the level meter 10 in FIGS. 46 and 47 will be described as another example of individual screens in the level meter 10 of FIGS. 1 and 2. FIG. 48 illustrates another example of the bottom distance setting screen 211. The bottom distance setting screen 211 is not greatly different from the bottom distance setting screen 211 (FIG. 17) in the level meter 10 of FIGS. 1 and 2, but the guidance display of “Determine” or “Return” does not appear at the bottom of the screen for the sake of screen space. In the level meter 10 in FIGS. 46 and 47, the determination may be performed by operating the menu key 32. In addition, in some screens, options for returning to a screen for which setting is already completed are preferably prepared. In addition, a function similar to “Return” may be realized by a combination of keys included in the operation unit 30. For example, in a case where the menu key 32 and the up key 36 are operated at the same time, it is preferable that an operation similar to that in a case where a key (the left key 38) corresponding to “Return” is operated in the level meter 10 in FIGS. 1 and 2 is performed (the display content of the display portion 20 returns to the previous screen).

FIG. 49 illustrates another example of the second threshold setting screen 320. As compared with the second threshold setting screen 320 (FIG. 20) in the level meter 10 of FIGS. 1 and 2, the normally open icon 324a, the normally closed icon 324b, the first threshold identifier 314, and the set value of the first threshold are not displayed, so that the display is simplified. However, the first threshold line 313 is displayed to be thin (for example, grayed out). In addition, a numerical value (here, 1500) of the height of the container 70 is displayed.

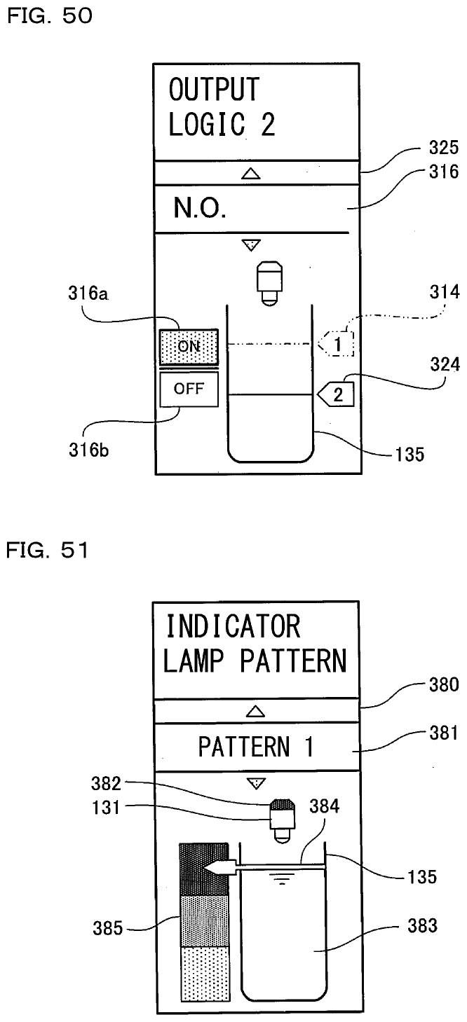

FIG. 50 illustrates another example of the output logic setting screen 325 for the second threshold. On the output logic setting screen 325 for the second threshold, the first threshold identifier 314 omitted on the second threshold setting screen 320 is displayed thin (for example, grayed out). Further, for convenience of display space, the ON icon 316a and the OFF icon 316b are displayed not next to the output logic setting field 316 but next to the container icon 135.

FIG. 51 illustrates another example of the indicator lamp pattern setting screen 380. As compared with the indicator lamp pattern setting screen 380 (FIG. 22) in the level meter 10 of FIGS. 1 and 2, the display is simplified because the identifier of each threshold is not displayed. Further, in the level meter 10 in FIGS. 46 and 47, since the indicator lamp 52 is disposed in the upper part of the level meter 10, the indicator lamp icon 382 is displayed in the upper part of the level meter icon 131 in FIG. 51.

Also on the indicator lamp pattern setting screen 380 of FIG. 51, an animation image showing the change in the operation of the level meter 10 with the increase and decrease of the level Y is displayed. That is, while the indicator lamp pattern setting screen 380 is displayed, the virtual bar display 383 repeats expansion and contraction, and the state of the indicator lamp icon 382 and the actual state of the indicator lamp 52 change as the virtual bar display 383 expands and contracts.

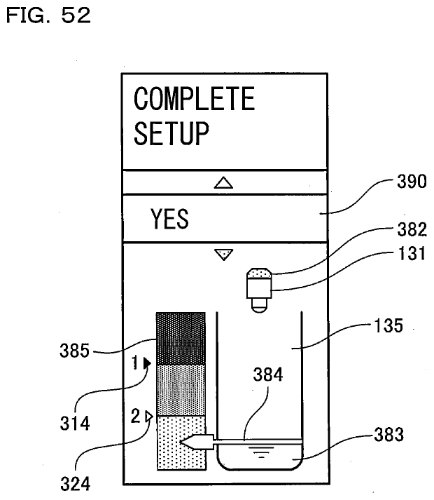

FIG. 52 illustrates another example of the setup completion confirmation screen 390. On the setup completion confirmation screen 390, the downsized first threshold identifier 314 and second threshold identifier 324 are displayed at the position of the boundary of each section of the virtual color gauge 385. As compared with the setup completion confirmation screen 390 (FIG. 25) in the level meter 10 of FIGS. 1 and 2, the display is simplified because the numerical values of the respective thresholds are not displayed. Also on the setup completion confirmation screen 390 in FIG. 52, the virtual bar display 383 repeats expansion and contraction, so that an animation image showing a change in the operation of the level meter 10 accompanying the increase and decrease of the level Y is displayed.

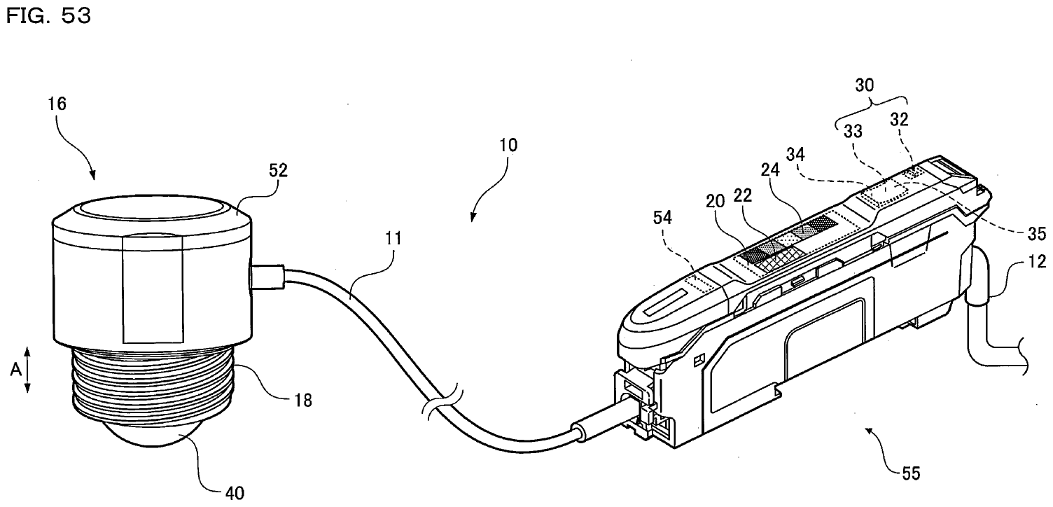

Next, still another example of the level meter 10 will be described with reference to FIG. 53. FIG. 53 is a perspective view illustrating still another example of the level meter 10. In FIG. 53, components having the same functions as those of level meter 10 in FIGS. 1 and 46 are denoted by the same reference numerals as those in FIGS. 1 and 46, and the description thereof will not be repeated unless necessary.

In FIG. 53, the level meter 10 includes the sensor unit 16 and a remote controller 55 that can communicate with the sensor unit 16 at a position away from the sensor unit 16. Then, the sensor unit 16 and the remote controller 55 are connected by a communication cable 11. In the level meter 10 of FIG. 53, only the sensor unit 16 is attached to the container 70 that contains the object 72, and the remote controller 55 communicates with the sensor unit 16 at a position away from the container 70.

As illustrated in FIG. 53, the sensor unit 16 has a generally cylindrical shape. The indicator lamp 52 is provided in the upper part of the sensor unit 16. The remote controller 55 corresponds to the housing 15 in the level meter 10 in FIGS. 1 and 46, and includes a display portion 20 that performs display according to the measured level Y. The display portion 20 can display the bar display 22 and the color gauge 24. In addition, the remote controller 55 includes the operation unit 30 for the user to operate the operation of the level meter 10. Furthermore, the remote controller 55 has the connection portion 12 serving as a connection terminal with an external device. In addition, the remote controller 55 includes a remote indicator lamp 54. The remote indicator lamp 54 is lit in the same lighting state as the indicator lamp 52 of the sensor unit 16.

The display portion 20 of the level meter 10 in FIG. 53 displays various types of information similarly to the display portion 20 of the level meter 10 in FIGS. 1 and 46. In the display portion 20 of FIG. 53, the information indicated to the user by the display portion 20 of FIG. 53 is equivalent to the case of FIGS. 1 and 46. The display content by the display portion 20 in FIG. 53 may be simplified according to the size of the display portion 20.

What is claimed is:

1. A level meter installed in an upper part of a container toward a bottom of the container to measure a level of an object stored in the container, the level meter comprising:
a transmission/reception unit including a transmission circuit that transmits a measurement signal for measuring the level, and a reception circuit that receives a reflection signal associated to reflection of the measurement signal by the object;
a level determination unit that determines the level based on the reflection signal received by the reception circuit and container information on the container;
a setting unit that sequentially sets the container information and a plurality of level setting values related to the level determined by the level determination unit; and
a display configured to display, based on the level determined by the level determination unit, the container information, and the level setting value, a relative position of the level setting value with respect to the container together with a bar display in which a length expands and contracts according to a value of the level determined by the level determination unit.

2. The level meter according to claim 1, wherein the display includes a plurality of sections arranged along an expansion/contraction direction of the bar display, and displays a gauge in which a position of a boundary of the sections is determined based on the container information and the level setting value, thereby displaying a relative position of the level setting value with respect to the container.

3. The level meter according to claim 1, wherein
the setting unit sets at least a height of the container or a distance from the level meter to a bottom of the container as the container information on the container, and
the display displays a relative position of the level setting value with respect to the container and displays a value of a height of the container or a value of a distance from the level meter to a bottom of the container.

4. The level meter according to claim 1, wherein when the container information and the level setting value are set by the setting unit, the display displays a container icon indicating the container and a level meter icon indicating the level meter.

5. The level meter according to claim 1, wherein after a plurality of the level setting values are set by the setting unit, the display collectively displays respective numerical values of the set level setting values together with respective relative positions of the level setting values with respect to the container.

6. The level meter according to claim 1, wherein the display displays together a level setting value identifier individually allocated to a plurality of the level setting values set by the setting unit and a numerical value of the level setting value corresponding to the level setting value identifier.

7. The level meter according to claim 1, wherein the display displays an animation image showing a change in operation of the level meter as the level increases or decreases.

8. The level meter according to claim 1, further comprising an indicator lamp whose lighting state changes according to a relationship between the level determined by the level determination unit and the level setting value set by the setting unit,
wherein the display displays an animation image including a virtual bar display that virtually indicates expansion and contraction of the bar display as the level increases or decreases, and an indicator lamp icon that virtually indicates a change in a lighting state of the indicator lamp as the level increases or decreases.

9. The level meter according to claim 8, wherein an actual lighting state of the indicator lamp changes in conjunction with a change in a lighting state of the indicator lamp icon accompanying expansion and contraction of the virtual bar display.

10. The level meter according to claim 8, wherein the setting unit sets a change pattern of a lighting state of the indicator lamp as the level increases or decreases.

11. The level meter according to claim 1, wherein the display includes a two-wire reflective color liquid crystal display that performs both power transmission and reception and data communication by two power lines.

12. The level meter according to claim 1, wherein
the setting unit is capable of performing resetting processing of changing the container information and the level setting value that have already been set, and
the display displays a relative position of the level with respect to the container or a value of the level for the level at present determined by the level determination unit when the resetting processing by the setting unit is performed.

13. The level meter according to claim 1, wherein
when the setting unit sets the level setting value, the display displays a normally open icon indicating that an operation of the level meter changes in a case where the level determined by the level determination unit exceeds the level setting value and a normally closed icon indicating that an operation of the level meter changes in a case where the level determined by the level determination unit falls below the level setting value,
the normally open icon is arranged above the normally closed icon in the display, and
the setting unit determines whether an operation of the level meter changes in a case where the level exceeds or falls below the level setting value depending on which of the normally open icon and the normally closed icon is selected.
